(19) United States
(12) Patent Application Publication
(10) Pub. No.: US 2026/0289000 A1
(43) Pub. Date: Sep. 24, 2026

(54) QUANTUM-SAFE DOCUMENT, DRIVE AND PROCESS MANAGEMENT FOR CONTRACT OF THINGS AND DOCUMENT OF THINGS

(71) Applicant: SHELTERZOOM CORP., New York, NY (US)

(72) Inventors: Chao CHENG-SHORLAND, New York, NY (US); Amir Homayoun ALISHAHI, New York, NY (US)

(73) Assignee: Shelterzoom Corp., New York, NY (US)

(21) Appl. No.: 19/688,127

(22) Filed: May 26, 2026

Related U.S. Application Data
(63) Continuation-in-part of application No. 17/312,535, filed on Aug. 28, 2020.
(60) Provisional application No. 62/893,329, filed on Aug. 29, 2019.

(51) Int. Cl. G06F 21/62; G06F 21/64; H04L 9/08; H04L 9/32

(52) U.S. Cl. CPC G06F 21/6227; G06F 21/6209; G06F 21/64; H04L 9/0852; H04L 9/3213; G06F 2221/2141

(57) ABSTRACT

Disclosed herein are system, method, and computer program product for managing documents using blockchain technology and quantum-safe computational architecture. A smart drive system may facilitate the creation of a project data structure encrypted using a quantum-resistant cryptographic scheme and distributed or decentralized key management functionalities. The project data structure may indicate a sequence or flow of documents and/or document types. The smart drive system may also manage groups of documents and generate documents and group tokens to manage access permissions. The smart drive system may protect these data sources from unauthorized access based on the quantum tokens corresponding to the document, document type, and/or group of documents. The smart drive system may facilitate modifications to the document from other parties, which may represent counteroffers or a negotiation process. The smart drive system may also interconnect documents of a project data structure to create documents with pre-filled data and corresponding cryptographic bindings.

### CROSS-REFERENCE TO RELATED APPLICATIONS

The present application is a continuation-in-part of U.S. application Ser. No. 17/312,535, filed Jun. 10, 2021, which is the U.S. National Phase of PCT/US2020/048503 filed Aug. 28, 2020, which claims priority to U.S. Provisional Application No. 62/893,329 filed Aug. 29, 2019, which are hereby incorporated by reference in their entireties.

### BACKGROUND

This field is generally related to quantum-safe document, folder, and process tokenization, management, and creation using blockchain technology, their applications to create, deliver, disseminate and collaborate on confidential documents, as well as their applications, to manage documents related to projects, processes, transactions, records, certifications, and/or other documents in a manner that includes quantum-resistant cryptographic schemes.

As individuals, businesses, and governments interact, parties often exchange many documents to accomplish projects or to complete transactions. These documents may include written specifications for a project or may be contractual obligations. For example, several documents may be needed to execute a transaction, such as a purchase of property, goods, or services. The documents may preserve contractual obligations or evidence the completion of a step in the transaction.

Similarly, when tracking the completion of a project, several documents may be needed to demonstrate the completion of each step. For example, for a construction project, a contract may be needed to begin the project while a specification document may describe formal metrics of the structure to be built. Another document may include a receipt indicating the purchase of the materials for the project. Additionally, a final acceptance document may be required that is signed by the parties of the project.

Managing this documentation may be difficult for several reasons. Typically, electronic document files are not structured or tied to the particular transaction or project. In this manner, data errors within the document files may create inconsistencies. Document management systems do not manage the content of the document files. Further, document management systems lack a flow of documentation to complete a transaction or project. This flow is important for tracking the status of a project and providing guidance for document management. This is especially true when multiple parties are involved with the transaction or project. Based on these issues, conventional file storage systems lack the ability to create dynamic and fit-for-purpose document structures corresponding to a process flow. They are merely a replication of a manual filing cabinet. Conventional files and folders are an antiquated technological concept that constraints and limits the growth of business and the world's e-Commerce in general.

These challenges intensify with the advancement of quantum technologies, which threaten the effectiveness of conventional encryption methods. Conventional document management systems are vulnerable to quantum decryption techniques, further jeopardizing the security, provenance, and downstream processing of the documents and additional data contained therein. For instance, conventional document management systems may be built as centralized repositories that rely on traditional cryptographic techniques. This makes conventional document management systems vulnerable to tampering and future cryptographic threats such as post-quantum attacks. These systems lack cryptographically verifiable mechanisms for tracking data provenance and evolution, are operationally fragile due to single points of failure that require disruptive restore processes, and provide insufficient isolation and trust guarantees for integrating intelligent or AI-driven processing. As a result, conventional platforms cannot manage sensitive in computational environments requiring strong integrity, auditability, resilience, and context-aware computations.

### BRIEF SUMMARY

Disclosed herein are system, apparatus, device, method and/or computer program product embodiments, and/or combinations and sub-combinations thereof, for managing documents, drives and processes using blockchain technology and quantum-safe computational architecture.

In an embodiment, a smart drive system may facilitate and manage documents using document tokens, group or folder tokens, digital wallets, and a blockchain. The smart drive system may also use a project data structure to organize documents, document types, folders, and/or sub-folders into a sequence for completing a project, transaction, and/or process. The organization of these documents using the smart drive system provides a flow for the management of documents for completing a project. In some embodiments, the project data structure may be used to manage documents and/or a lifecycle of documents related to a “thing,” such as a person, property, animal, asset (e.g., boat, car, collectible artwork), and/or other objects. In this manner, the documents corresponding to the project or “thing” may be interconnected, which may provide a document of things or contract of things interconnectivity. In some embodiments, the smart drive system may manage different groupings of documents using group or folder tokens. The project data structure and/or the documents within the smart drive system may be protected using quantum-resistant cryptographic schemes and/or a distributed or decentralized key management system to enhance the security of the smart drive system.

The smart drive system may receive and/or generate documents for completion. The smart drive system may leverage a tokenization layer that converts the documents and/or folders into cryptographically verifiable representations that preserve their origin, structure, and history. This enables organizations to track how information evolves over time while ensuring that every interaction with a file is transparent and auditable. Upon receipt or completion of a document, the smart drive system may update the project data structure with the tokenized document. The smart drive system may also update group or folder tokens corresponding to the project data structure. The smart drive system may then identify another document from the sequence for completion. In some embodiments, the smart drive system may also analyze common data values between received documents to aid in generating subsequent documents. By identifying patterns of data, the smart drive system may more quickly generate documents for completion of the project. Further, the smart drive system may maintain an interconnectedness between documents of the project to maintain consistency throughout the documents. The smart drive system may also store a hash of the documents and/or a hash of a group of documents on a blockchain to preserve the documents in an immutable manner. For instance, the hash generated in such a way that protects the document against quantum-based decryption techniques. This may provide additional confidence that the one or more documents have been preserved and are free from tampering or accessible via quantum decryption technologies or other technologies.

The smart drive system may operate in several contexts. For example, the smart drive system may aid in completing projects or transactions. These may include construction projects for example. A construction project may include a group of interrelated documents. Each of the interrelated documents may share mechanisms that employ quantum-resistant cryptographic schemes. The smart drive system may manage these documents, create documents for the project, and also prompt users to provide requisite documents. Similarly, the smart drive system may manage a merger or acquisition transaction by managing relevant documents related to due diligence and contracts. The smart drive system may also manage supply chain interactions with multiple parties. For example, the smart drive system may provide a “contract of things” between sellers, buyers, distributers, consumers, and/or other parties of a supply chain. In some embodiments, the smart drive system may manage a lifecycle of documents corresponding to a person, property, animal, asset (e.g., boat, car, collectible artwork), and/or other object.

### BRIEF DESCRIPTION OF THE DRAWINGS

The accompanying drawings are incorporated herein and form a part of the specification.

FIG. 1 depicts a block diagram of a document management environment with a smart drive system, according to some embodiments.

FIG. 2 depicts a flow diagram illustrating a communications flow for managing documents corresponding to a project or transaction, according to some embodiments.

FIG. 3 depicts a flowchart illustrating a method for creating a project data structure, according to some embodiments.

FIG. 4 depicts a flowchart illustrating a method for updating a project data structure, according to some embodiments.

FIG. 5 depicts a flowchart illustrating a method for generating a document template within a project data structure, according to some embodiments.

FIG. 6 depicts a flowchart illustrating a method for updating a project data structure depending on a document type, according to some embodiments.

FIG. 7 depicts a flowchart illustrating a method for propagating document data, according to some embodiments.

FIG. 8 depict a block diagram depicting group tokens and document tokens, according to some embodiments.

FIG. 9 depicts a flowchart illustrating a method for generating a group token, according to some embodiments.

FIG. 10 depicts a block diagram of a document management system with a smart drive system implementing quantum-safe mechanisms, according to some embodiments.

FIG. 11 depicts a flowchart for managing documents within the smart drive system implementing quantum-safe mechanisms, according to some embodiments.

FIG. 12 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for managing documents using blockchain technology and quantum-safe computational architecture. The embodiments disclosed herein may facilitate the generation of a document by providing a front-end user interface while managing the document using a connected, associated, or related back-end system interfaced with a blockchain. The related back-end system may employ quantum-resistant cryptographic schemes as well as distributed or decentralized key management functionalities to ensure the security of projects in a post-quantum environment. The front-end may be a user interface such as a graphical user interface (GUI) that allows a user to manage a flow of documents. This flow of documents may correspond to a project or transaction. Similarly, one or more parties corresponding to the project or transaction may create, access, supply, and/or modify the documents corresponding to the flow.

These complications compound as quantum technologies put traditional encryption methods at risk. Conventional document management systems are vulnerable to quantum decryption techniques, further jeopardizing the security, provenance, and downstream processing of the documents contained therein. For instance, conventional document management systems may be built as centralized repositories that rely on traditional cryptographic techniques, making them vulnerable to tampering and future cryptographic threats such as post-quantum attacks. For example, many conventional document management systems rely exclusively on asymmetric cryptographic techniques (e.g., Rivest-Shamir-Adleman (RSA) cryptography) to govern document management principles such as access control, identify verification, and modifications. As quantum computing threatens to break these conventional cryptographic techniques, stored documents can be decrypted and modified by unauthorized parties, digital verification measures (e.g., document signatures) lose integrity and trust, and access controls (e.g., document tokens and/or key pairs) can be forged. These advances threaten to disintegrate trust in conventional document management systems.

Computational shortcomings are especially noticeable in centralized, passive storage systems used for metadata and version control, which require implicit trust despite the above-listed cryptographic limitations. For instance, conventional systems do not have mechanisms indicating for providing cryptographically enforced proof that a version history is complete or untampered. Rather, auditability depends on policy compliance as opposed to objective, mathematical-based verification techniques. Funneling security compliance through a single point of failure as opposed to robust technical measures introduces extensive system outages and threatens the integrity of the document data itself. These problems are even further compounded in systems using Artificial Intelligence (AI)-driven processing. Context boundaries between projects, clients, and/or tenants in conventional document management systems are weak, enabling AI tools to introduce cross-context data contamination between project data structures. Moreover, the inputs and outputs of an AI tool are not cryptographically bound to the source data they analyzed, degrading trust in AI tool operations as results are not reliably grounded in trusted data sources.

Accordingly, conventional approaches lack cryptographically verifiable mechanisms for tracking data provenance and evolution, are operationally fragile due to single points of failure that require disruptive restoration processes, and provide insufficient isolation and trust guarantees for integrating AI-driven document processing. As a result, existing platforms cannot manage sensitive documents in computational environments that require strong computational integrity, auditability, resilience, and context-aware software infrastructure.

The disclosed embodiments herein improve upon conventional document management systems with a quantum-safe, tokenized “virtual folder” that secures documents and/or other data within a project data structure, or other computational workspaces. Documents and data sources may be represented as cryptographically verifiable tokens that present structure, origin, and modification history. This enables improved data provenance, auditing, and access control mechanisms to be implemented amongst the data sources themselves. The virtual folders and/or additional project data structures may be protected by quantum-resistant cryptographic controls and decentralized or distributed key management, ensuring that access, editing, sharing, and other control actions are governed by verifiable computational security mechanisms rather than implicit trust in a centralized repository. For instance, the virtual folders may encrypt documents and control access measures using post-quantum cryptographic primitives, such as, but not limited to, lattice-based key encapsulation and signatures. Therefore, data sources cannot be effectively decrypted as quantum computing continues to evolve. Additionally, key materials and/or access authorities may be distributed across multiple system components as opposed to a single point of trust. Accordingly, no single authority can decrypt or modify stored document tokens without satisfying verifiable access constraints.

The embodiments therefore provide continuous access to authentic data even during system failures or cyber incidents, eliminating reliance on traditional restore processes. At the same time, the embodiments enable trusted, context-aware intelligent processing: AI tools operate within cryptographically isolated workspaces and generate outputs that are traceable to verified source documents while preserving strict separation between folders. Together, these features transform static file repositories into secure, quantum-resistant, and intelligent smart drive system with secure project data structures.

Users may interact with a smart drive system to define a project data structure and/or a flow of documents and/or document types. The smart drive system may be a cloud-based platform and/or may be a software-as-a-service (SaaS) application that manages documents, document types, and/or projects. By defining a project data structure with a flow of documents and/or document types, the smart drive system may manage and organize documents to facilitate the completion of a project and/or a transaction. In some embodiments, the project data structure may identify a process and/or a lifecycle of documents. Further, by maintaining document templates, the smart drive system may facilitate the creation of documents for a particular flow. Upon completion and/or execution of the document, the smart drive system may indicate that a particular document has been completed and may identify a subsequent document in the flow for completion. The smart drive system may receive the document and/or verify a received document for indicating completion. The smart drive system may also generate a document for completion and identify when the generated document has been completed. Upon determining that a document has been supplied in a flow, the smart drive system may update the project data structure and may identify a subsequent document for completion.

In some embodiments, the smart drive may also use a smart folder structure to organize templates, documents, and/or contracts. This smart folder structure may correspond to the project data structure and may group documents. For example, a particular smart folder may group documents corresponding to a part of a transaction, negotiation, project, deal, and/or process flow. In some embodiments, the smart folder may organize interrelated and/or unrelated documents, entities, or elements. The project data structure may provide a flow and/or organization for one or more smart folders. The smart folders may also be nested into sub-folders. As discussed above, each smart folder structure (also referred to as a “virtual folder”) may be protected using quantum-resistant cryptographic schemes and distributed or decentralized key management. These folders function as secure containers, where access, edits, and sharing are governed by verifiable cryptographic controls rather than implicit trust in a central system. For instance, the smart drive system may generate a folder-scoped cryptographic mechanism using a post-quantum cryptographic mechanism (e.g., lattice-based key encryption) and encryption keys may be stored directly to the smart folder structure. Additionally, other authentication key measures may be bound to document versions and events (e.g., creation, modification, dissemination) within the smart folder structure. Accordingly, data within one smart folder structure may be cryptographically isolated from others. Entities and AI tools engaging within the smart drive system may be appropriately compartmentalized within the specific folders, sub-folders, and other project data structures within the smart drive system.

The smart drive system may also use document tokens, group tokens, and/or folder tokens to manage documents, drives and processes. As will be further explained below, document tokens may be used to represent ownership and/or permissions corresponding to a document. A document token may be a non-fungible type of token to digitally represent a tokenized document such as record, certificate, document, agreement and contract, held by stakeholders with various levels of permissions. Similarly, a group or folder token may be a non-fungible type of token to digitally represent a tokenized folder or a structure which contains a hash of parent folder/group token ID(s), sub folder/group token ID(s), document token ID(s), folder owner, issue date and folder participants etc., held by stakeholders with various levels of permissions. The smart drive system may execute a hash algorithm on a group of documents to generate a group and/or folder token. In some embodiments, the smart drive system may execute a post-quantum cryptographic measure in addition to or separately from the hash algorithm. For instance, the smart drive system may execute a lattice-based cryptographic measure on the document, group of documents, and/or a folder to generate a quantum token. The document token, group token, and/or folder token may be platform-agnostic. Further, the document token, group token, and/or folder token may be attached and/or detached from a project data structure. In some embodiments, using document tokens, group tokens, and/or folder token in the project data structure may provide a hierarchical structure, a folder structure, and/or a process management organization.

In some embodiments, the smart drive system may manage documents using a blockchain interface. For example, on either a public or private blockchain, documents may be published and/or tracked. The smart drive system may calculate a hash of a document and/or a group of documents and store the hash on the blockchain. Similarly, the smart drive system may execute a lattice-based cryptographic measure on the document, group of documents, and/or a folder to generate a quantum token, which may also be stored on the blockchain. In some embodiments, the smart drive system may execute code on the blockchain using smart contract functions. The publication to a blockchain may provide security and trust that completed documents are immutable. Further, distributed ledger technology may provide a streamlined manner of tracking modifications to documents and presenting these modifications to parties communicating and/or editing a document. As will be further described below, the embodiments described herein further provide faster and more efficient back-end processing for blockchain operations. In particular, the use of asynchronous calls to the blockchain may provide increased speed and may avoid delays related to blockchain transaction times.

The embodiments described herein may further be used in contract negotiations to provide a streamlined contract platform for tracking and viewing offers and counteroffers. For example, the smart drive system may generate a multi-party contract as a document in a project data structure. In some embodiments, the contract may be an offers to purchase goods, services, property, insurance, and/or other contractual obligations. The smart drive system may also facilitate counteroffers and/or negotiations of contractual terms and/or manage digital signatures representing an acceptance of an offer. In this manner, the smart drive system may facilitate the execution of a contract document. This execution may be tracked as part of the flow of a project data structure. These contractual documents may be managed by a blockchain, which allows parties to operate in a more trusted manner. The smart drive system may streamline a negotiation process that preserves confidentiality while maintaining a high degree of trust.

In some embodiments, the smart drive system may use AI tools, agents, or other AI-based models to analyze and interact with documents, document data, and/or other components of the smart drive system in a context-aware manner. “Context-aware” AI mechanisms may refer to machine-readable execution context defined by the cryptographic constraints governing the project data structure. For example, the smart drive system may enforce AI tools to evaluate a document (e.g., an input) that is cryptographically verified, authorized, and/or current within the project data structure. For instance, the smart drive system may configure the AI mechanisms to ignore or otherwise prevent execution towards a document and document token that cannot be cryptographically verified or is not bound to the project data structure's cryptographic identity, such as via hash comparison, signature verification, and/or the like.

In this manner, the smart drive system may manage a flow of documents to aid in facilitating projects, transactions, and/or process flows. The smart drive system may receive and/or organize documents based on a project data structure. The smart drive system may also generate documents and/or interconnect document data to aid in maintaining consistency. This document management configuration aids in reducing the number of user interactions and computational transactions while also reducing network traffic.

Various embodiments of these features will now be discussed with respect to the corresponding figures.

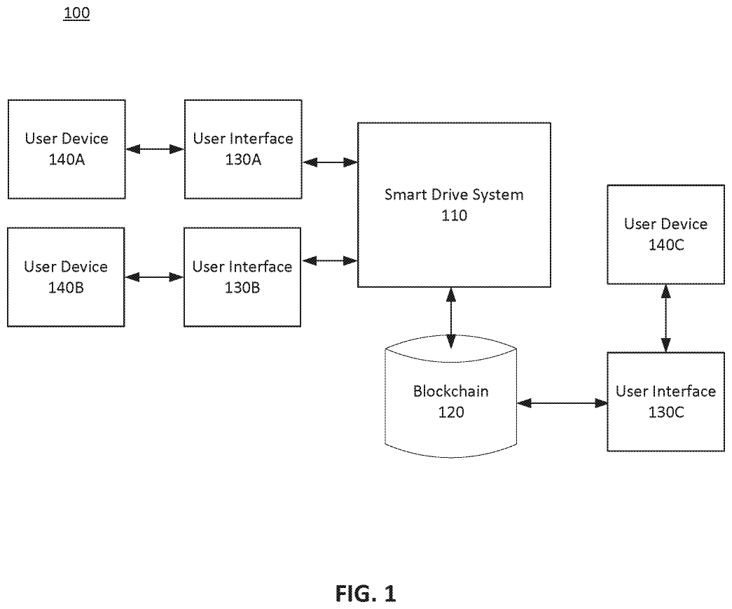

FIG. 1 depicts a block diagram of a document management environment 100 with a smart drive system 110, according to some embodiments. In addition to smart drive system 110, document management environment 100 may include blockchain 120, user interfaces 130, and/or user devices 140. Smart drive system 110 may include one or more servers and/or databases that may instantiate user interfaces 130A-130B for user devices 140A-140B. Smart drive system 110 may include object storage, a web service interface, storage for Internet applications, and/or cloud computing and/or storage. Smart drive system 110 may be a cloud-based platform and/or may be a software-as-a-service (SaaS) application that manages documents, document types, and/or projects. In some embodiments, smart drive system 110 may use a peer-to-peer network and/or protocol for storing and/or sharing data in a distributed file system. For example, smart drive system 110 may use content-addressing to uniquely identify files in a global namespace to network user devices 140. In some embodiments, smart drive system 110 may use the InterPlanetary File System (IPFS) protocol and/or servers such as Amazon S3®.

Smart drive system 110 may include an interface with blockchain 120. Blockchain 120 may be a private or public blockchain. Smart drive system 110 may use one or more smart contract functions to interface and/or publish data to blockchain 120. The smart contract functions may include protocols to digitally facilitate, verify, and/or enforce transactions. The transactions may be trackable and irreversible. As will be further described below, smart drive system 110 may interface with blockchain 120 to store data representing documents and/or modifications to documents. This data may include a cryptographic hash of a document and/or a link to a human-readable representation of the document. Smart drive system 110 may use this storage to ensure immutability when tracking a flow of documents corresponding to a project data structure.

In some embodiments, smart drive system 110 may also manage document, group, and/or folder tokens, which may also be managed using blockchain 120. As will be further explained below, the document tokens may represent ownership and/or permissions for documents and/or document modifications. Group or folder tokens corresponding to a smart folder organization may organize documents and/or document tokens into portions of a project data structure. For example, document tokens may include metadata corresponding to folder tokens indicating a folder structure for the documents. Different users may have different permissions depending on digital wallets corresponding to the user having a particular document token, group token, and/or folder token.

In some embodiments, document tokens may correspond to different group tokens and/or folder tokens. If a document token corresponds to multiple group tokens and/or folder tokens, smart drive system 110 may perform deduplication and avoid the storage of redundant copies of the underlying document data. In this manner, a user may apply a document token to different project data structures. Further, the user may associate a document token with different group and/or folder tokens in the same or different project data structures. For example, a user's driver's license may have a document token corresponding to a folder token for a “Personal Identity” folder. This folder may be a project data structure corresponding to management of the user's personal records. The user may define other project data structures, such as a “Fishing License Application” folder or a “Travel Visa Application” folder having the document token corresponding to the driver's license. In some embodiments, a document token may correspond to a pre-qualification for purchasing a house. A realtor may place this document token into several property folders for consideration and preparation to make an offer. In this manner, the document token may be a “single source of truth” as maintained by blockchain 120 for multiple groups.

When defining a project data structure and/or generating a group or folder token corresponding to the project data structure, smart drive system 110 may identify several metadata fields. For example, the metadata may include a type for the project data structure, such as a Transaction, Project, Negotiation, Deal, Planning, Procurement, Other Process, Templates, Documents, Record Keeping, Other. The metadata may also allow a sub-type designation such as Real Estate, Development, Technology, M&A, Financial, Supply Chain, Procurement Recruitment, HR, Other. The metadata may allow a user to designate whether to enable automatic population of data. The metadata may also include permissions data as well as identification data including a title, description, date of creation, creator/owner data, role of the creator, a state (e.g., draft, in progress, complete), and/or other custom fields.

In some embodiments, a group or folder token may provide expanded security when attached to structures, hierarchies, document elements or fields, templates, and/or documents. For example, the group or folder token may allow for the designation of roles for permissions. These roles may include an owner or creator of a group token; a manager assigned by the owner who may manage the group token (e.g., manage users and permissions, edit metadata, configure contract execution rules, and/or delete the project); an editor of content; an acknowledger who may acknowledge receipt of a group token; a viewer of the content; and/or a shared viewer who may share permissions. In some embodiments, invitees may have the same permissions as the inviter. In some embodiments, an invited user may already have different permissions, however, which may or may not be overwritten.

In some embodiments, users may have different permissions for different documents within a group and/or project data structure. For example, John may have an Edit permission for the Group L1, but may only have an Acknowledge permission for doc1; a Shared View permission for doc2; and a Comment permission for sub-Group B. When John invites Mary to Group L1 with the Edit permission, smart drive system 110 may automatically assign Mary with John's same permissions for doc1, doc2 and sub-Group B respectively. In this manner smart drive system 110 may prevent an inviter from providing permissions that are beyond the inviter's own permissions.

As previously explained, to generate a group or folder token, a user may define a project data structure. In some embodiments, the user may use a GUI to select a template group. For example, a real estate transaction group may include document templates used for listings, sales, and closing documents for a state. A predefined template may provide these documents and save users of the industry time while aiding with compliance for state rules and regulations. Similarly, a project data structure may be used by a human resources onboarding process. The documents may include company policies, directives for new employee to acknowledge, and/or agreements for signature. While templates for project data structures may exist, users may also modify these templates and/or adjust the documents in the project data structure. For example, documents may be added, re-ordered, and/or removed. In some embodiments, rules may be re-defined such as for smart contracts. Users may also modify the grouping of documents. Similarly, users may modify the content of a document.

By managing the document tokens, group tokens, and/or folder tokens using a project data structure, smart drive system 110 may manage a flow and/or sequence of documents. For example, smart drive system 110 may maintain a project data structure that organizes documents and/or folders with documents. In some embodiments, smart drive system 110 may organize multiple documents and/or folders of documents into a flow or sequence to aid in the completion of a project and/or a transaction. The folders may also be nested into sub-folders. To initialize this flow, a user may create a project data structure and/or select a project data structure from a template. In some embodiments, the project data structure may not include a sequence. For example, the project data structure may allow for the submission of documents corresponding to a list of documents. In some embodiments, this listing may not require an ordering in the submission of documents.

The user may interface with smart drive system 110 via a front-end user interface 130. Smart drive system 110 may provide a front-end user interface 130 to allow users to supply, create, manage, edit, and/or modify documents. Further, user interface 130 may allow users to manage a project data structure, corresponding documents, and/or a sequence of documents corresponding to the project data structure. User interface 130 may be a graphical user interface (GUI) that may be accessed and/or displayed on a user device 140. User device 140 may be a computer, laptop, tablet, phone, and/or other device that may access the Internet and/or display a user interface 130. User interface 130 may include an application programming interface (API) to provide communications between user device 140 and smart drive system 110.

As will be further explained below, smart drive system 110 may provide a front-end GUI including GUI elements allowing a user to create a project data structure, identify a document and/or document type flow or sequence corresponding to the project data structure, submit document files, create documents, modify documents, manage document permissions, manage document modifications from other parties, manage a digital wallet, manage user account information and/or account roles, and/or other document interactions. This GUI may be displayed on user device 140 using user interface 130. In some embodiments, smart drive system 110 may facilitate the incorporation of GUI elements into web pages not managed by smart drive system 110 to allow users to access the operations provided by smart drive system 110. For example, smart drive system 110 may provide a web widget that may be incorporated, integrated, or overlaid onto other web pages to provide similar project and/or document functionality.

For example, smart drive system 110 may generate an icon and/or button allowing a user to create a project data structure. The user may interact with the icon or button via a selection, press, or click on a GUI. In response to this interaction, smart drive system 110 may generate a project creation GUI element displayed on the GUI. The project creation GUI element may display document type options and/or folder options for managing the documents corresponding to the project. The project may represent, for example, a project, transaction, and/or process for completion. By interacting with the project creation GUI element, a user may identify the particular documents and/or document types for the project.

In some embodiments, the user may select from a list of available project templates to create a project data structure. A project template may include a list of documents and/or folders. The project template may arrange the documents and/or folders into a flow or sequence. The user may adjust this flow or sequence if desired by interacting with the project creation GUI. For example, the project creation GUI may include example projects and/or transaction templates. These templates may include, for example, construction projects, real estate transactions, supply chain management projects, e-commerce transactions, personal information management, and/or other projects and transactions. By selecting a project template, smart drive system 110 may generate a list of documents, document types, and/or folders for completion of the project. The user may add, remove, modify, and/or re-arrange these documents in the sequence. As will be further explained below, users may supply and/or create the listed documents and/or document types in order to complete the corresponding project. Smart drive system 110 may track and/or verify the document submissions. Smart drive system 110 may further aid in creating documents when identifying a pattern of common document data across the documents.

Returning to the project creation GUI, smart drive system 110 may also allow a user to create a project data structure by specifying documents, document types, and/or folders. The user may specify a document by selecting from a list of document templates and/or by entering a name of the document. Upon selecting multiple documents and/or document templates, the user may arrange the documents and/or document templates into a flow or sequence. For example, a user may identify a project as a construction of a new road or highway. The user may then specify several documents for the completion of this project. These documents may include a contract with a construction company, a specifications document for the road, a receipt for the cost of materials, an inspection document identifying satisfactory construction, and/or other documents required for the completion of the project. The user may then group these documents into folders and/or arrange the documents into a flow or sequence. This arrangement may provide an interconnection between the documents and/or may allow smart drive system 110 to analyze and detect common data within the documents. With this data, smart drive system 110 may generate and/or populate subsequent documents with the common data. This common data may be, for example, names, addresses, prices, amounts, and/or other data fields common between documents. In this manner, the flow or sequence of a project may aid in the automatic generation of other documents.

In some embodiments, the project data structure may not include a sequence. For example, the project data structure may include a grouping of documents which may be completed. Completion and/or submission of documents within a group of documents may not include a particular ordering. In some embodiments, the group may be the whole project data structure or may be a portion of a project data structure. For example, when the group includes the whole data structure, no sequence may be defined. When the group is a portion of the project data structure, the group may be sequenced with other documents and/or groups. Documents within the group may not be sequenced. In some embodiments, access to a group may depend on the completion of previously defined documents and/or other groups.

Upon creating a project data structure and/or a flow or sequence of documents, a user may submit documents to smart drive system 110. The submission of documents may indicate a completion of a step in a project or transaction. For example, the project data structure may indicate a particular document or document type required. The user may upload a document file using user device 140 to submit the indicate document or document type. Upon receiving the document, smart drive system 110 may indicate that the document and/or step of the project has been completed. Smart drive system 110 may then identify a subsequent document for the user to provide to continue the project.

In some embodiments, smart drive system 110 may generate a document for the user to complete as part of a project data structure. For example, smart drive system 110 may include templates of documents and/or contract documents. A law firm may create these templates. Smart drive system 110 may provide these templates for purchase and for use by a user. These templates may include invoices, contracts for goods and/or services, rental documents, lease documents, and/or other documents corresponding to a project or transaction. In some embodiments, the user may complete the document by providing information and/or filling fields of information corresponding to the document. Smart drive system 110 may detect when a party has completed a document. For example, when the user has completed the requisite fields and/or when the user has indicated that the document is complete. For example, the document may be an invoice for the purchase of construction materials. Upon supplying the relevant information such as material type, price, quantity, and buyer information, smart drive system 110 may indicate that the invoice has been completed.

In some embodiments, the document generated by smart drive system 110 may be a contract and/or a document corresponding to multiple parties. For example, smart drive system 110 may facilitate an offer and acceptance or negotiation process to manage the completion of a document by multiple parties. This negotiation process may include one or more rounds of offers and counteroffers between parties. A user may specify conditions and/or obligations using smart drive system 110 to generate a contractual document for execution by another user. Smart drive system 110 may deliver this contract document to the other party to notify the party of the pending contract. For example, smart drive system 110 may provide a notification via electronic mail or via a push notification to a user device 140 corresponding to the user. The parties may digitally negotiate using smart drive system 110 and modify different portions of a document. For example, the parties may negotiate different contractual terms and/or obligations. Smart drive system 110 may use a tokenization process to manage different portions of a document and/or to manage counteroffers. This negotiation and/or document editing may also occur between multiple parties.

Upon completion of the editing, parties may provide digital signatures indicating an acceptance of the terms. When the document has been completed, smart drive system 110 may update the project data structure to reflect a completion of the document. Smart drive system 110 may then identify a next document. In some embodiments, smart drive system 110 may analyze the document to aid in pre-filling subsequent documents in the project data structure. For example, smart drive system 110 may identify party names, projects specifications, prices, quantities, dates, addresses, and/or other data to pre-fill into other documents corresponding to the project data structure. Smart drive system 110 may analyze fillable forms to extract this data. In some embodiments, smart drive system 110 may use machine learning, artificial intelligence, deep learning, neural networks, and/or other machine learning techniques to identify patterns of common data among the received or created documents. In this manner, smart drive system 110 may provide interconnectivity between documents. This interconnectivity may be especially relevant to the project and aiding to more quickly generate documents using data common to the project.

In some embodiments, smart drive system 110 may apply this intelligence to identify elements and/or fields of a document. The identification of the fields and/or elements may aid in the interconnectivity of the documents managed by smart drive system 110. For example, as previously explained, the identification of these values may aid in pre-filling fields of other documents. By extracting these values, smart drive system 110 may transform unstructured data and/or document files into structure data. Smart drive system 110 may identify values corresponding to data fields. Smart drive system 110 may then populate other documents having the same data fields with these values. This structuring may provide interconnectivity across a project, transaction, process, records, and/or lifecycle of documents. In some embodiments, smart drive system 110 may manage these documents for a “thing” such as a person, property, animal, asset (e.g., boat, car, collectible artwork), and/or other objects. In this manner, the documents corresponding to the “thing” may be interconnected, which may provide a document of things or contract of things interconnectivity.

In some embodiments, smart drive system 110 may also identify documents related to records and/or certificates. A project data structure may indicate that a record or certificate is a document required for completion of a document or transaction. In some embodiments, a user may create a personal project and/or a personal project data structure used for managing personal documents. For example, a user may use smart drive system 110 to manage and/or preserve documents corresponding to the user using blockchain 120. In this case, the documents identified in the project data structure may correspond to the user. These documents may include certificates such as a birth certificate, marriage certificate, driver's license, college degree, and/or other documents which a user may deem as being official. In some embodiments, the documents may include medical records. The preservation on blockchain 120 may indicate that the document is authentic. For example, a university, government agency, and/or other institutions may preserve documents on blockchain 120 related to a user to confirm the authenticity of the document and/or that a particular certificate was actually issued by the institution. Smart drive system 110 may manage document tokens related to these certificates and/or transmit document tokens to digital wallets corresponding to a user. The user may be able to use smart drive system 110 to track, view, and/or manage documents throughout a user's lifetime. Smart drive system 110 may provide a repository for these documents while maintaining confidentiality and providing verifiable proof of authenticity.

In some embodiments, this project data structure may also be applied to other “things” such as property or assets. In this manner, smart drive system 110 may manage a lifecycle of documents related to different objects. If ownership of a particular object changes (e.g., via a transaction), the project data structure may operate as a repository for the document related to the object. Ownership and/or permissions related to the project data structure may also change.

In some embodiments, a user may import preserved documents into another project data structure to add the document to that project. For example, the document may be personal information or a certificate. Similarly, if a document is common to multiple projects, that document may be referenced by the projects. In some embodiments, smart drive system 110 may store the document with references to multiple projects rather than replicating the document multiple times. This may reduce the storage required as well as network bandwidth usage by not requiring a user to re-upload documents already stored by smart drive system 110.

Upon receiving and/or completing a document, smart drive system 110 may store the document using blockchain 120. As will be further explained below, smart drive system 110 may store an encrypted version of the document and/or create a link to the encrypted version of the document. Smart drive system 110 may also generate a cryptographic hash of the document. Smart drive system 110 may store the hash of the document on blockchain 120. Using this information along with other information such as an owner identification and/or other metadata, smart drive system 110 may create a document token corresponding to the document. The document token may represent ownership of the document and/or may be transmitted to a digital wallet corresponding to the user. Smart drive system 110 may use the document token in future operations to determine access and/or modification permissions. In some embodiments, smart drive system 110 may transmit the document token to another party to allow the other party to access and/or modify the document. For example, the document token may indicate that a buying party may modify the document with a digital signature to accept a contract document.

Smart drive system 110 may manage the document using blockchain 120. For example, smart drive system 110 may publish the cryptographic hash of the document and/or the link to the encrypted version of the document using smart contract functions. The document may be encrypted using a key corresponding to the user and/or administrator of the project. Publishing the document data onto blockchain 120 may preserve the trustworthiness of the document and the legitimacy of the offer and/or content. For example, the immutable nature of blockchain 120 may protect against unauthorized document modifications or tampering. Further, the cryptographic hash may preserve privacy and may prevent other users of the blockchain 120 from viewing confidential information. For example, user device 140C may be utilizing a separate user interface 130C to access blockchain 120 separately from token server system 110. The encryption may prevent user device 140C from viewing the confidential information stored on blockchain 120.

Based on the publishing of documents to blockchain 120, smart drive system 110 may manage documents corresponding to a project as well as preserve confidence corresponding to the documents. In this manner, smart drive system 110 may aid in project and/or transaction completion by managing and preserving relevant documents. This management and preservation also allows for document interconnectivity to aid in generating documents based on documents submitted by a user. In this manner, smart drive system 110 provides a project management tool for preserving a sequence of documents as well as a process for generating new documents corresponding to a project or transaction.

Other functions and/or operations of smart drive system 110 will now be further described with reference to the other figures of this disclosure.

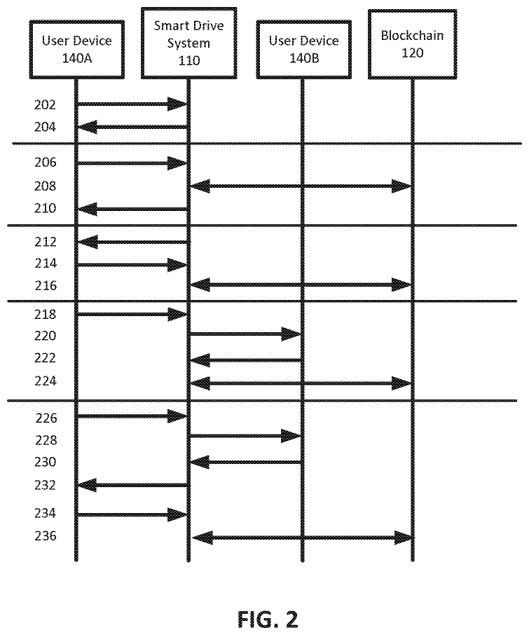

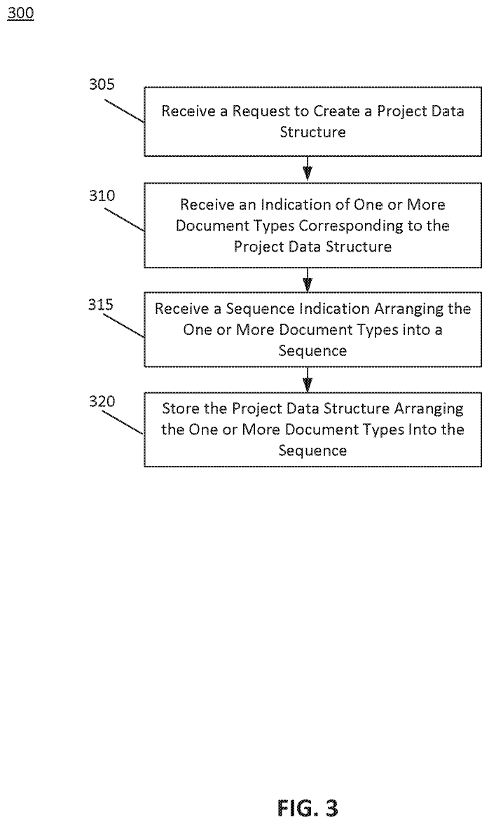

FIG. 2 depicts a flow diagram illustrating a communications flow 200 for managing documents corresponding to a project or transaction, according to some embodiments. Communications flow 200 includes interactions between user device 140A, smart drive system 110, user device 140B, and/or blockchain 120. Communications flow 200 describes an embodiment for creating a project data structure and/or supplying documents to complete a project. The processes described with respect to communications flow 200 are further described with reference to FIGS. 3 through 9.

Elements 202 and 204 of communications flow 200 depict the exchange of messages to create a project data structure. At 202 and 204, user device 140A may exchange messages with smart drive system 110 to create a project data structure. For example, a user may interact with a project creation GUI displayed on user device 140A to identify a project. Using user device 140A, the user may select from possible project templates. In some embodiments, the user may specify particular documents and/or document types for the project. The user may specify an arrangement or flow of documents corresponding to the project. In response to commands exchanged between user device 140A and smart drive system 110, smart drive system 110 may define a project data structure indicating a list of documents, document types, and/or folders with a specific arrangement or flow.

Elements 206, 208, and 210 of communications flow 200 depict the submission of a document from user device 140A to smart drive system 110. In response to identifying a project data structure, user device 140A may submit a document to fulfill an element of the project. In some embodiments, this document may be the next in a sequence of documents. Smart drive system 110 may prompt user device 140A via a GUI display indicating the document to be submitted. User device 140A may submit the document via an upload to a server of smart drive system 110. In some embodiments, this submission may occur via a message such as an email to a designated address of the smart drive system 110. In some embodiments, if user device 140A provides access to a cloud computing platform, which also includes access to smart drive system 110, the user may select a document within the cloud computing platform to submit. In this manner, the user may designate a document file via the cloud computing platform.

Upon receiving the document submission, smart drive system 110 may publish the document to blockchain 120. As previously explained, smart drive system 110 may hash and/or encrypt the document prior to publishing the document to blockchain 120. In some embodiments, smart drive system 110 may analyze the contents of the document to extract data for generating new documents. For example, smart drive system 110 may compare the content of the document to previously stored documents. Smart drive system 110 may similarly identify fields and/or data values corresponding to the fields to transform unstructured data into structured data. At 210, smart drive system 110 may indicate to user device 140A that the document has been successfully submitted. Smart drive system 110 may also indicate a subsequent document and/or document type for a user to supply.

Elements 212, 214, and 216 of communications flow 200 depict the generation of a document by smart drive system 110. In response to identifying a project data structure, smart drive system 110 may identify that possibility of creating a document template at 212. Smart drive system 110 may indicate this possibility to user device 140A via a GUI display. A user wishing to create the document using smart drive system 110 may indicate this desire by interacting with the GUI. At 214, the user may provide additional information to complete the document. For example, the user may provide data by filling-in fields of a document. In some embodiments, the user may edit the text of a document template. Upon completion of the document, smart drive system 110 may provide an indication and/or update the project data structure. At 216, smart drive system 110 may publish the created document to blockchain 120. As previously explained, smart drive system 110 may hash and/or encrypt the document prior to publishing the document to blockchain 120.

Elements 218, 220, 222, and 224 of communications flow 200 depict the completion of a document involving multiple parties. At 218, user device 140A may indicate the submission and/or creation of a document to smart drive system 110. User device 140A may indicate a document for completion by user device 140B. In this case, at 220, smart drive system 110 may notify user device 140B for user device 140B to complete the document. For example, user device 140B may provide additional information, data, and/or modifications to the document at 222 to complete the document. The smart drive system 110 may update the project data structure to indicate a completion of the document by user device 140B. As previously explained, smart drive system 110 may hash and/or encrypt the document prior to publishing the document to blockchain 120.

Elements 226, 228, 230, 232, 234, and 236 of communications flow 200 depict the negotiation and completion of a document involving multiple parties. The document may be, for example, a contract. User device 140A may submit and/or create a contract document at 226. For example, user device 140A may specify contract terms and/or identify the parties to the contract. At 228, smart drive system 110 may notify user device 140B for user device 140B to execute the contract or to complete the document. At 230, user device 140B may further modify the document or complete the document by providing additional information. For example, user device 140B may alter a term of the contract using a GUI provided by smart drive system 110. Upon identifying the modification, smart drive system 110 may notify user device 140A at 232. Smart drive system 110 may update the GUI displayed on user device 140A to identify the modification. In the case where user device 140A has accepted the modifications and has indicated an acceptance at 234, smart drive system 110 may update the project data structure to indicate a completion of the document. At 236, smart drive system 110 may publish the completed document to blockchain 120. As previously explained, smart drive system 110 may hash and/or encrypt the document prior to publishing the document to blockchain 120.

Based on communications flow 200, smart drive system 110 may identify the documents required to satisfy a project data structure. Smart drive system 110 may facilitate the management and preservation of these documents using blockchain 120. Smart drive system 110 not only allows user device 140A to submit or upload documents, but also facilitates the creation of documents. When creating documents, smart drive system 110 may also pre-fill data based on documents previously submitted and/or completed. This interconnectedness between documents may allow for the more efficiency creation and completion of documents for a project data structure.

FIG. 3 depicts a flowchart illustrating a method 300 for creating a project data structure, according to some embodiments. Method 300 shall be described with reference to FIG. 1; however, method 300 is not limited to that example embodiment.

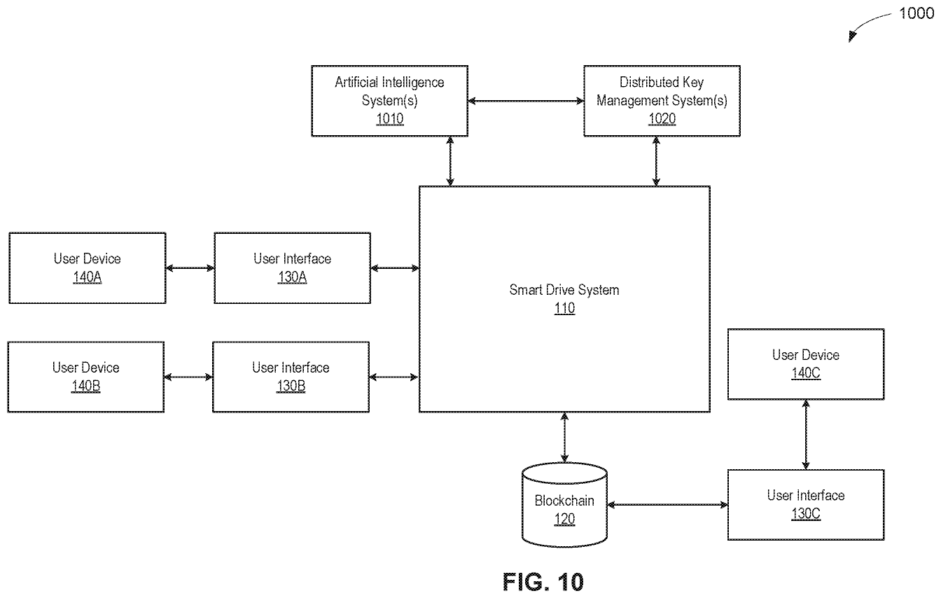

In an embodiment, smart drive system 110 may facilitate the generation of a project data structure. The project data structure may indicate a sequence of documents, document types, and/or folders organizing documents. The project data structure may aid in providing a sequence of documents for completion of a project or transaction. While method 300 is described with reference to smart drive system 110, method 300 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3, as will be understood by a person of ordinary skill in the art.

At 305, smart drive system 110 may receive a request to create a project data structure. For example, a user device 140 may provide a command via a user interface 130 to smart drive system 110. A user may navigate a GUI to indicate the creation of a project data structure. This project data structure may correspond to a project, transaction, and/or process. The project data structure may be metadata, which indicates list of documents, document types, folders, and/or a sequence of documents, document types, or folders. In some embodiments, the project data structure may represent a flow where a user supplies a document earlier in the sequence before supplying a document later in the sequence. In some embodiments, the project data structure may allow a user to provide documents independent of the defined flow. For example, if the project data structure includes a folder, a user may submit documents corresponding to the defined folder independent of a sequence within the folder.

At 310, smart drive system 110 may receive an indication of one or more document types corresponding to the project data structure. A user using a user device 140 may define a set of documents and/or document types when creating the project data structure. This set of documents may indicate the documents for completion of the project or transaction. In some embodiments, a selection of a project data structure template may derive the one or more document types. The documents and/or document types may refer to specific documents and/or a category of acceptable documents. For example, a document type may specify a category such as a “contract” while a specific document may be a “letter of intent.” In some embodiments, a document type may be a categorical designation and/or may refer to a specific document.

At 315, smart drive system 110 may receive a sequence indication arranging the one or more document types into a sequence. This sequence may be a flow as explained above. In some embodiments, the documents may be organized into folders and/or folders may be organized into a sequence. As previously explained, the sequence and/or flow may define a sequence of documents. Submission and/or completion of a document in the flow may cause smart drive system 110 to identify a subsequent document in the flow for completion.

At 320, smart drive system 110 may store the project data structure arranging the one or more document types into the sequence. Smart drive system 110 may store this project data structure in a database. Smart drive system 110 may associate this project data structure with one or more user accounts so that the user accounts may provide the documents specified by the project data structure.

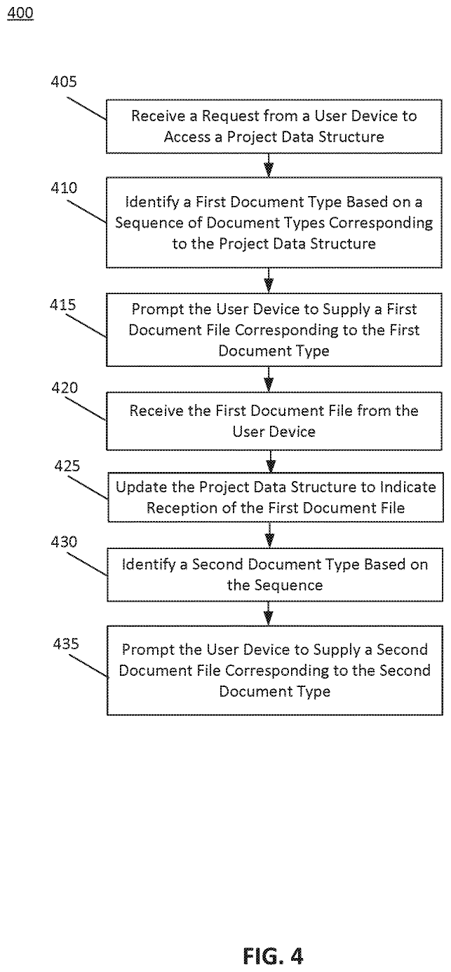

FIG. 4 depicts a flowchart illustrating a method 400 for updating a project data structure, according to some embodiments. Method 400 shall be described with reference to FIG. 1; however, method 400 is not limited to that example embodiment.

In an embodiment, smart drive system 110 may facilitate the completion of a project data structure by receiving and/or completing documents corresponding to the project data structure. Upon receiving and/or completing a document, smart drive system 110 may update the project data structure. While method 400 is described with reference to smart drive system 110, method 400 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4, as will be understood by a person of ordinary skill in the art.

At 405, smart drive system 110 may receive a request from a user device 140 to access a project data structure. This project data structure may have been previously defined with a sequence or flow of one or more documents and/or document types. Smart drive system 110 may receive the request via an interaction with a GUI.

At 410, smart drive system 110 may identify a first document type based on a sequence of document types corresponding to the project data structure. If no documents have been previously submitted for this project data structure, the first document type may be the first in the sequence. If documents have been previously submitted or completed, the first document type may be a following document type in the sequence. As previously explained, the document type may be a broad category of documents and/or may refer to a specific document. The specificity of the document may be variable.

At 415, smart drive system 110 may prompt the user device 140 to supply a first document file corresponding to the first document type. This prompt may be a display on a GUI displayed on the user device 140. In some embodiments, this prompt may be a notification and/or message to the user requesting the submission of the first document file. The prompt may vary depending on the specificity of the first document type. For example, if the first document type identifies a broad category, such as an “Invoice,” the prompt may reflect the broad category. In some embodiments, the first document type may be specific, such as “Invoice from XYZ Construction Co.” In this case, the prompt may be more specific.

At 420, smart drive system 110 may receive the first document file from the user device 140. User device 140 may upload the first document file to smart drive system 110. In some embodiments, in a cloud system, user device 140 may designate the first document file over a network. Upon receiving the first document file, smart drive system 110 may perform a verification to determine whether the first document file satisfies the first document type indicated by the project data structure. For example, smart drive system 110 may analyze metadata and/or content of the first document file to determine whether a satisfactory document has been supplied. Smart drive system 110 may identify fields of content within the document to determine whether the fields match expected content. In some embodiments, smart drive system 110 may notify an administrator of the project data structure to review the supplied first document file and to determine whether it is satisfactory.

At 425, smart drive system 110 may update the project data structure to indicate reception of the first document file. In some embodiments, this update may occur in response to verifying that the first document file satisfies the first document type. Updating the project data structure may include marking the submission of the first document type. In this manner, when accessing a GUI to view the documents of the project data structure, a user may see an indication that the document has been submitted. The user may interact with the GUI to view the document. In some embodiments, smart drive 110 may also preserve the received document file by publishing the document to blockchain 120 as previously discussed.

At 430, smart drive system 110 may identify a second document type based on the sequence. The second document type may be a subsequent document type after submission of the first document type. In some embodiments, smart drive system 110 may unlock the ability to submit the second document type in response to receiving the submission of the first document type. In this manner, smart drive system 110 may control the flow and/or sequence of the submitted documents. In some embodiments, a user may be permitted to submit multiple different document types independent of the sequencing. For example, if the sequence includes a folder, document types listed in the folder may be submitted independent of the sequence of their listing. In some embodiments, the folder may be arranged in sequence with other document types to further control the sequencing.

At 435, smart drive system 110 may prompt the user device 140 to supply a second document file corresponding to the second document type. This prompt may be similar to 415. If the second document file completes the sequence, smart drive system 110 may indicate the completion of the project data structure. In this manner, smart drive system 110 may preserve the documents corresponding to the project data structure while facilitating the reception of documents to complete the project, transaction, or process.

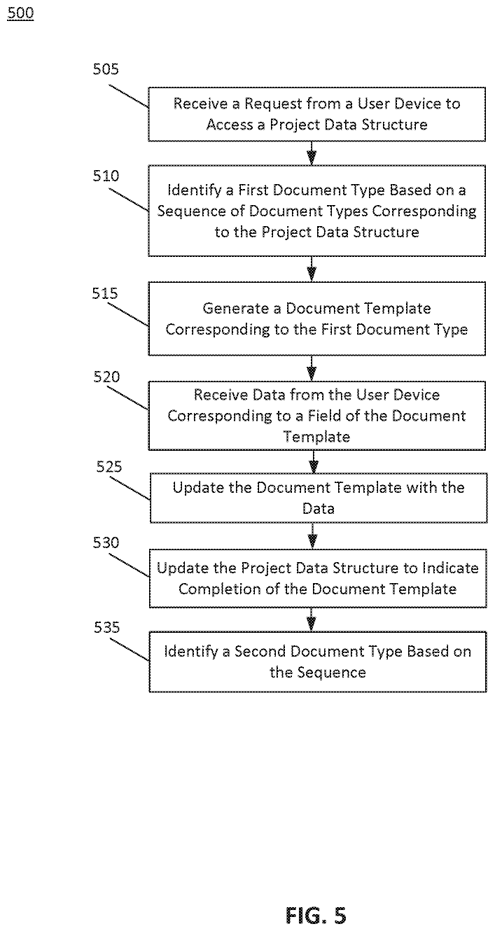

FIG. 5 depicts a flowchart illustrating a method 500 for generating a document template within a project data structure, according to some embodiments. Method 500 shall be described with reference to FIG. 1; however, method 500 is not limited to that example embodiment.

In an embodiment, smart drive system 110 may facilitate the completion of a project data structure by receiving and/or completing documents corresponding to the project data structure. Upon receiving and/or completing a document, smart drive system 110 may update the project data structure. While method 500 is described with reference to smart drive system 110, method 500 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5, as will be understood by a person of ordinary skill in the art.

At 505, smart drive system 110 may receive a request from a user device 140 to access a project data structure. This project data structure may have been previously defined with a sequence or flow of one or more documents and/or document types. Smart drive system 110 may receive the request via an interaction with a GUI.

At 510, smart drive system 110 may identify a first document type based on a sequence of document types corresponding to the project data structure. If no documents have been previously submitted for this project data structure, the first document type may be the first in the sequence. If documents have been previously submitted or completed, the first document type may be a following document type in the sequence. As previously explained, the document type may be a broad category of documents and/or may refer to a specific document. The specificity of the document may be variable.

At 515, smart drive system 110 may generate a document template corresponding to the first document type. The document template may be a fillable and/or editable document corresponding to the first document type. Using the document template, a user may supply data and/or information to complete the document. At 520, smart drive system 110 may receive data from the user device 140 corresponding a field of the document template. At 525, smart drive system 110 may update the document template with the data. The user may interactively supply data to complete the document. In some embodiments, smart drive system 110 may pre-fill data in the document template based on an analysis of previously supplied documents. This data may be determined based on an analysis of previously supplied data. The user may supply additional data and/or modify existing data to complete the document.

In some embodiments, the document may require input from multiple parties. The document may be, for example, a contract. The parties may modify the document and/or negotiate terms. In this case, smart drive system 110 may facilitate the negotiations and/or the execution of the contracts. For example, smart drive system 110 may receive a modification of the document template from a second user device. Smart device system 110 may notify the first user device of the modification. Smart drive system 110 may also provide different response options such as accepting the modification, rejecting the modification, counteroffering, and/or other responses. If the modification is rejected or the first user device supplies a counteroffer, smart drive system 110 may notify the second user device of this response. The parties may continue negotiations which smart drive system 110 may facilitate. If the modification is accepted, smart drive system 110 may also notify the second user device and/or may update the project data structure at 530 to indicate the acceptance.

At 530, smart drive system 110 may update the project data structure to indicate completion of the document template. In some embodiments, this update may occur in response to verifying the data supplied. Updating the project data structure may include marking the completion of the first document type. In this manner, when accessing a GUI to view the documents of the project data structure, a user may see an indication that the document has been completed. The user may interact with the GUI to view the document. In some embodiments, smart drive 110 may also preserve the completed document file by publishing the document to blockchain 120 as previously discussed.

At 535, smart drive system 110 may identify a second document type based on the sequence. The second document type may be a subsequent document type after completion of the first document type. In some embodiments, smart drive system 110 may unlock the ability to submit the second document type in response to completing the first document type. In this manner, smart drive system 110 may control the flow and/or sequence of the completed documents. In some embodiments, a user may be permitted to complete multiple different document types independent of the sequencing. For example, if the sequence includes a folder, document types listed in the folder may be completed independent of the sequence of their listing. In some embodiments, the folder may be arranged in sequence with other document types to further control the sequencing.

Smart drive system 110 may also prompt the user device 140 to complete a second document template corresponding to the second document type. The user may complete the document in a manner similar to 520. Smart drive system 110 may also pre-fill common data in the second document template. If the second document template completes the sequence, smart drive system 110 may indicate the completion of the project data structure. In this manner, smart drive system 110 may preserve the documents corresponding to the project data structure while facilitating the completion of documents to complete the project, transaction, or process.

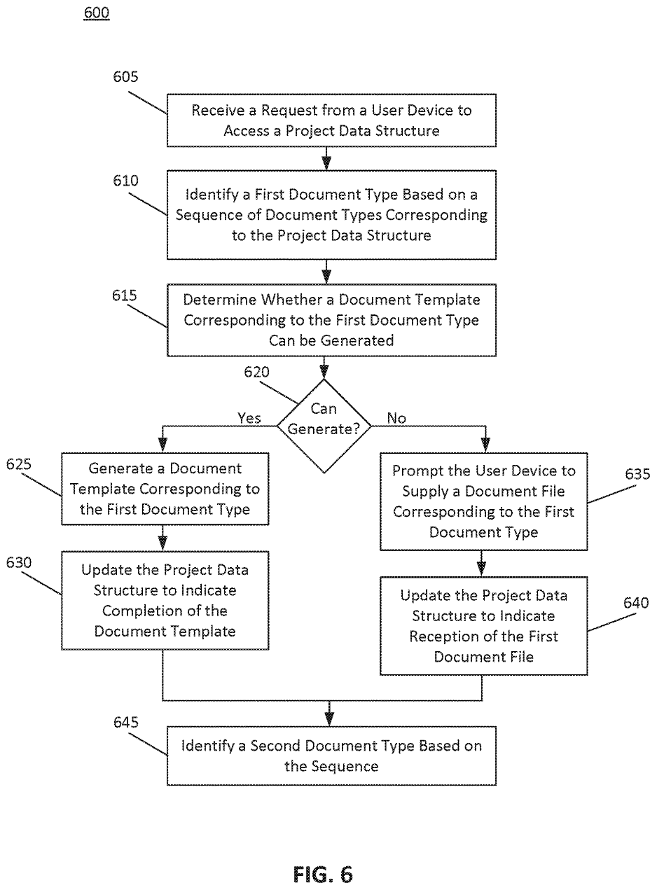

FIG. 6 depicts a flowchart illustrating a method 600 for updating a project data structure depending on a document type, according to some embodiments. Method 600 shall be described with reference to FIGS. 1, 4, and 5; however, method 600 is not limited to that example embodiment.

In an embodiment, smart drive system 110 may facilitate the completion of a project data structure by receiving and/or completing documents corresponding to the project data structure. Upon receiving and/or completing a document, smart drive system 110 may update the project data structure. While method 600 is described with reference to smart drive system 110, method 600 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 6, as will be understood by a person of ordinary skill in the art.

At 605, smart drive system 110 may receive a request from a user device 140 to access a project data structure. This request is similar to the request from 405 and 505 as described with reference to FIGS. 4 and 5 respectively. At 610, smart drive system 110 may identify a first document type based on a sequence of document types corresponding to the project data structure. This identification is similar to the request from 410 and 510 as described with reference to FIGS. 4 and 5 respectively. In an embodiment, the project data structure may include documents to be submitted by a user device 140 as well as documents generated by smart drive system 110 and to be completed by the user.

At 615, smart drive system 110 may determine whether a document template corresponding to the first document type can be generated. For example, smart drive system 110 may check a library or database of available document types for which it can generate a document template. In some embodiments, a user may restrict a project data structure to require the submission of document rather than allowing the use of a document template. In this case, smart drive system 110 may request a submission rather than provide a document template for a user to utilize. At 620, smart drive system 110 may determine whether to generate a document template.

If smart drive system 110 can generate a document template, smart drive system 110 may generate the document template corresponding to the first document type at 625. For example, smart drive system 110 may check a database to determine whether a document template exists. If so, similar to 515 and 520, a user may add data and/or modify the document template to complete the document. When the document is complete, smart drive system 110 may update the project data structure to indicate completion of the document template at 630. This update may be similar to 425 and 530 as described with reference to FIGS. 4 and 5 respectively.

If smart drive system 110 cannot generate a document template, smart drive system 110 may prompt the user device to supply a document file corresponding to the first document type at 635. Smart drive system 110 may not be able to generate a document template when checking a database and determining that one has not been stored. In response to determining that the database lacks the document template, smart drive system 110 may prompt the user device to supply the corresponding document file. Similar to 415 and 420, the user may supply the document to smart drive system 110. For example, a user device 140 may upload the document file, transmit the document file, and/or identify the document file in a cloud-based platform. Upon receiving the document, smart drive system 110 may update the project data structure to indicate reception of the first document file at 640. This update may be similar to 425 and 530 as described with reference to FIGS. 4 and 5 respectively.

At 645, smart drive system 110 may identify a second document type based on the sequence. This identification is similar to the identification from 430-435 and 535 as described with reference to FIGS. 4 and 5 respectively. In the case where the sequence includes documents that are generated by smart drive system 110 as well as documents that are supplied by the user, smart drive system 110 may iteratively perform method 600 until reception and/or completion of the documents listed in the project data structure.

To illustrate an example embodiment, a project data structure may include three document types in a sequence. The first and second document types may be submitted by a user while the third document type may be generated by smart drive system 110. In this case, smart drive system 110 may receive a request from a user device to access the project data structure, which identifies the sequence of document types. Smart drive system 110 may identify the first document type based on the sequence and prompt the user device to supply a first document file corresponding to the first document type. Smart drive system 110 may receive the first document file from the user device and update the project data structure to indicate reception of the first document file. Smart drive system 110 may identify a second document type based on the sequence and then prompt the user device to supply a second document file corresponding to the second document. In some embodiments, smart drive system 110 may execute method 600 to identify these documents.

When reaching the third document type of the sequence, smart drive system 110 may identify the presence of a document template corresponding to the third document type in a database. For example, smart drive system 110 may check the database to determine whether a document template corresponding to the third document type has been stored. If so, smart drive system 110 may generate a document template corresponding to the third document type. Smart drive system 110 may receive data from the user device corresponding to a field of the document template and update the document template with the data. Smart drive system 110 may then update the project data structure to indicate completion of the document template and the third document type. As previously explained, this process may occur iteratively until completion of the project, transaction, and/or process.

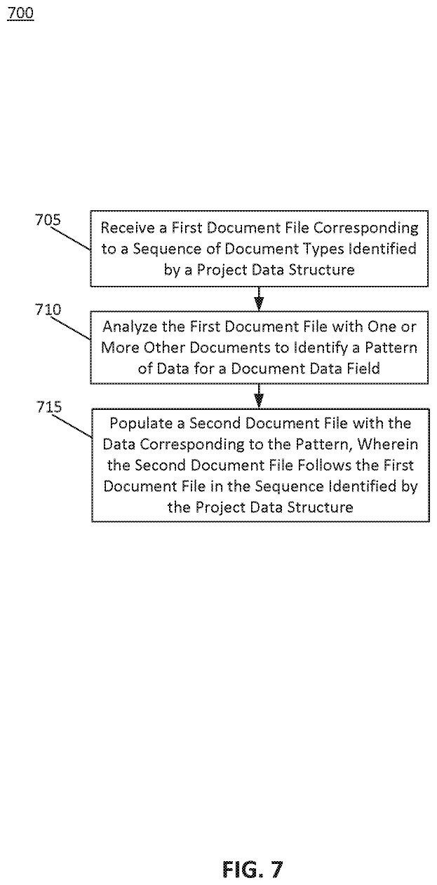

FIG. 7 depicts a flowchart illustrating a method 700 for propagating document data, according to some embodiments. Method 700 shall be described with reference to FIGS. 1, 4, 5, and 6; however, method 700 is not limited to that example embodiment.

In an embodiment, smart drive system 110 analyze received and/or completed documents to facilitate the creation of additional documents. Upon receiving and/or completing a document, smart drive system 110 may use machine learning, artificial intelligence, deep learning, neural networks, and/or other machine learning techniques to identify patterns of common data among the received or created documents. Smart drive system 110 may then include this data when creating new documents. While method 700 is described with reference to smart drive system 110, method 700 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 7, as will be understood by a person of ordinary skill in the art.

At 705, smart drive system 110 may receive a first document file corresponding to a sequence of document types identified by a project data structure. This may be similar to 420 as described with reference to FIG. 4. In some embodiments, smart drive system 110 may have stored previously received and/or created documents corresponding to the project data structure. The first document file may be the first in a sequence and/or may be a subsequent file in the sequence.

At 710, smart drive system 110 may analyze the first document file with one or more other documents to identify a pattern of data for a document data field. As previously explained, smart drive system 110 may use machine learning, artificial intelligence, deep learning, neural networks, and/or other machine learning techniques to identify patterns of common data among the received or created documents. Smart drive system 110 may use computer vision and/or optical character recognition to identify common data. By using the project data structure, smart drive system 110 may identify the interconnectedness of the documents and may extract the common data. In some embodiments, when establishing the project data structure, a user may also identify common fields and/or data values corresponding to those fields for the project. For example, common fields may include party names, addresses, contact information, dates, and/or other information. These fields may be common between documents of the project. Smart drive system 110 may compare these fields and corresponding values with detected values from the first document file. For example, smart drive system 110 may identify content of the first document file that matches content of a previous document of the sequence. This matching content may be used at 715 when generating a subsequent document file.

Similarly, smart drive system 110 may manage the documents as they relate to the particular project, transaction, process, record, and/or lifestyle management of a “thing.” For example, the documents may relate to a particular person, property, animal, asset (e.g., boat, car, collectible artwork), and/or other objects. In this manner, the documents corresponding to the “thing” may be interconnected, which may provide a document of things or contract of things interconnectivity. The matching content may be common among the documents corresponding to the “thing.”

In some embodiments, smart drive system 110 may also identify any discrepancies or non-matching data. A user may then correct this non-matching data. In this case, smart drive system 110 may use the corrected data when generating a subsequent document file.

At 715, smart drive system 110 may populate a second document file with the data corresponding to the pattern, wherein the second document file follows the first document file in the sequence identified by the project data structure. Smart drive system 110 may populate this information when generating a subsequent document in the project. The second document file may be a different document type than the first document file. In this manner, smart drive system 110 may analyze data, detect information common from multiple files, and generate new documents having this information even if the new document is of a different type. Smart drive system 110 may perform this population when executing 515 and/or 625 from methods 500 and 600 respectively. As other documents and/or document files are received or completed, smart drive system 110 may continue to analyze the new documents to identify new information and/or to update previously identified information. In this manner, smart drive system 110 may interconnect the documents and generate more accurate documents as the project, transaction, or process progresses.

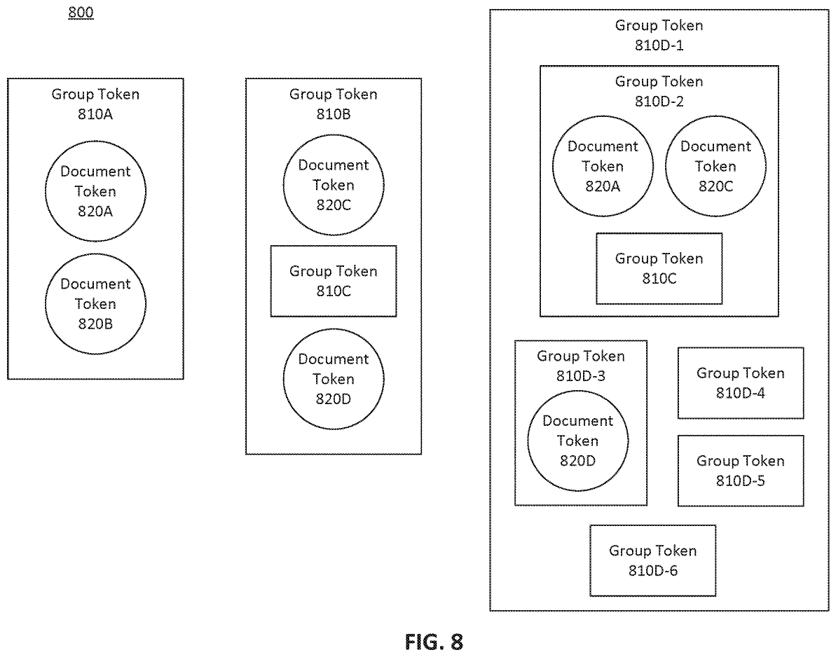

FIG. 8 depict a block diagram 800 depicting group tokens 810 and document tokens 820, according to some embodiments. Group tokens 810 and document tokens 820 may be generated to correspond to one or more project data structures as previously described. An example embodiment will be described with reference to FIG. 8 to describe the relationship between group tokens 810 and document tokens 820. Smart drive system 110 may manage the group tokens 810 and document tokens 820 for different users and/or parties. Smart drive system 110 may also apply hash algorithms to generate group tokens 810 and/or document tokens 820. Smart drive system 110 may manage digital wallets with these tokens to manage permissions related to the groups and/or documents.

In an embodiment, group tokens 810 may correspond to different aspects of a user Mary progressing through a home purchase process. Group token 810A may be a group token corresponding to a project data structure corresponding to Mary's household documents. Group token 810B may correspond to a project data structure managed by Mary's bank. Group token 810D-1 may correspond to a project data structure managed by Mary's real estate agent.

Document tokens 820A and 820B correspond to group token 810A. Document tokens 820A and 820B may be personal records submitted by Mary. For example, document token 820A may correspond to Mary's driver's license while document token 820B may correspond to Mary's passport. Mary may have submitted these documents based on a sequence and/or without a sequence of documents. Smart drive system 110 may manage and/or tokenize these documents. Smart drive system 110 may also generate group token 810A corresponding to these documents.

Group token 810B may correspond to a project data structure managed by Mary's bank. Group token 810B may include document token 820C, which may be a loan application. The bank may have issued the loan application and may be the owner of document token 820C.

Group token 810B may also include group token 810C. Group token 810C may correspond to a mortgage prequalification process. Group token 810C may include access to the document applicable to this process. As will be further described below, group token 810C may be shared with Mary's real estate agent within group token 810D-2.

Group token 810B may also include document token 820D. As will be further described below, document token 820D may be a shared document token with group token 810D-1. For example, document token 820D may correspond to a real estate sales contract. In this case, the bank as well as Mary's real estate agent may have permissions corresponding to the real estate sales contract. Depending on these permissions, the bank may be restricted to viewing the contract. Access to document token 820D, however, may allow the bank to confirm the execution of the contract.

Similar to the bank, Mary's real estate agent may manage group token 810D-1 corresponding to the real estate purchase process. Smart drive system 110 may identify permissions based on the group tokens 810 and/or document tokens 820. Group token 810D-1 may include group token 810D-2. This may present a hierarchy or nesting of group tokens 810. The hierarchy and/or nesting may represent sub-processes for an overall process. For example, group token 810D-2 may be part of the process of negotiation and may include the offer and acceptance aspect of the property purchase. Group token 810D-2 may include document token 820A, document token 820C, and/or group token 810C. These may correspond to Mary's driver's license, Mary's mortgage prequalification, and/or the group of documents corresponding to Mary's mortgage prequalification process. Group token 810D-2 may organize these tokens and/or permissions corresponding to these tokens. Group token 810D-1 may also include group token 810D-3, which may correspond to the sales portion of the property purchase. Group token 810D-3 may include document token 820D, which may correspond to the real estate sales contract. As previously explained, access to document token 820D may be shared with the bank managing group token 810B. In some embodiments, Mary's real estate agent may be provided permission to view the document based on document token 820D from an external issuer, such as Mary's law firm.

Group token 810D-1 may also include other group tokens 810D-4, 810D-5, and 810D-6. These group tokens may correspond to mortgage documents, title documents, and/or closing documents. In this manner, smart drive system 110 may manage document tokens 820 as well as group tokens 810 for different entities. Smart drive system 110 may also manage permissions, such as modification and/or viewing permissions, for the entities. By managing the documents and/or tokens using blockchain 120 and property of immutability, smart drive system 110 may maintain a “single source of truth” that entities may rely upon. In this manner, smart drive system 110 may streamline document and/or group management in a more trusted manner.

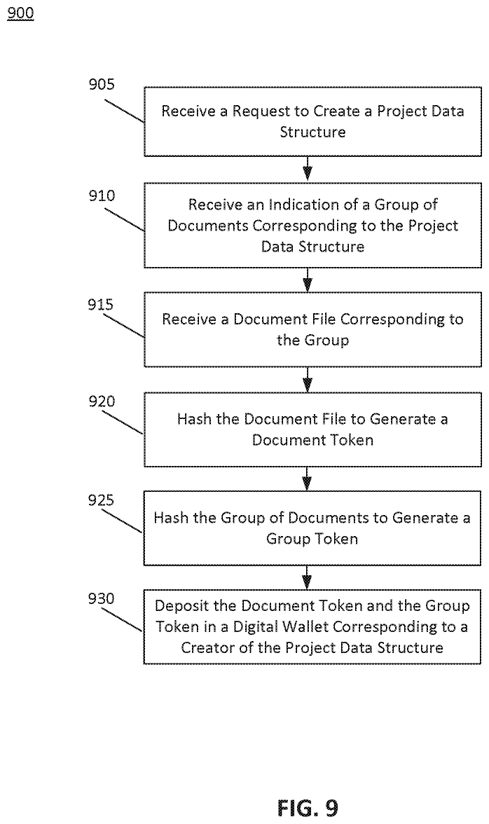

FIG. 9 depicts a flowchart illustrating a method 900 for generating a group token, according to some embodiments. Method 900 shall be described with reference to FIG. 1; however, method 900 is not limited to that example embodiment.

In an embodiment, smart drive system 110 may facilitate the generation of group and/or document tokens, which may correspond to a project data structure. While method 900 is described with reference to smart drive system 110, method 900 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 9, as will be understood by a person of ordinary skill in the art.

At 905, smart drive system 110 may receive a request to create a project data structure. For example, a user device 140 may provide a command via a user interface 130 to smart drive system 110. A user may navigate a GUI to indicate the creation of a project data structure. This project data structure may correspond to a project, transaction, and/or process. The project data structure may be metadata, which indicates list of documents, document types, folders, and/or groups. The project data structure may include groupings of documents which may or may not include a sequence of documents. In some embodiments, the project data structure may not include any sequence.

At 910, smart drive system 110 may receive an indication of a group of documents corresponding to the project data structure. This group of documents may be similar to those described with reference to FIG. 8. The indication of the group of documents may correspond to the entirety of the project data structure and/or may be a portion of the project data structure. The group of documents may be sequenced and/or may not be sequenced. When the group of documents is a portion of a project data structure, the group of documents may or may not be sequenced with other groups and/or documents.

At 915, smart drive system 110 may receive a document file corresponding to the group. This document file and/or document data may be submitted to the group and/or completed based on a template provided by smart drive system 110. In some embodiments, smart drive system 110 may receive a document file corresponding to the group.

At 920, smart drive system 110 may hash the document file to generate a document token. Smart drive system 110 may generate a document token corresponding to the document by applying a hash algorithm to the document. The hash algorithm may be a cryptographic hashing algorithm. This hash may provide confidentiality related to the document. The document token may also indicate permissions as previously described based on ownership of the document token in a digital wallet. For example, these permissions may include restricting access to only viewing the document.

At 925, smart drive system 110 may hash the group of documents to generate a group token. Smart drive system 110 may generate a group token corresponding to the group by applying a hash algorithm to documents of the group. This hash algorithm may be the same or different from the hash algorithm applied to the document. The generation of the group token may allow for a sharing of permissions similar to the document token. For example, providing the group token may allow viewing permissions for the documents in the group. Based on the management of the documents on blockchain 120, users may reliably depend on the documents when accessing them using the group token.

At 930, smart drive system 110 may deposit the document token and the group token in a digital wallet corresponding to a creator of the project data structure. By depositing these tokens in the digital wallet, the creator may access, modify, manage, and/or view the document and/or group. Smart drive system 110 may also update the project data structure to mark a submission of the document and/or a completion of the documents in the group. Smart drive system 110 may prompt the user to submit additional documents and/or indicate a completion of the project data structure. Similarly, the creator may share the document token and/or the group token with other parties. This sharing may indicate the submission or completion of the document and/or group of documents. The other parties may use these tokens to indicate a submission or completion corresponding to their own project data structures. Smart drive system 110 may identify and/or update these project data structures as well.

FIG. 10 depicts a block diagram of quantum-safe document management environment 1000 with a smart drive system 110, according to some embodiments. Quantum-safe document management environment 1000 may incorporate the features, functionalities, and other elements described with respect to FIGS. 1-9. For instance, quantum-safe document management environment 1000 may incorporate user device(s) 140, user interface(s) 130, blockchain 120, and smart drive system 110. Additionally, quantum-safe document management environment 1000 may include artificial intelligence (AI) system(s) 1010 and distributed key management system(s) 1020. Smart drive system 110 may include additional functionalities to interact with these elements in a quantum-safe manner, as will be described in further detail below.

Smart drive system 110, existing within quantum-safe document management environment 1000, may be implemented as a document management platform in which data integrity, provenance, and/or long-term security are priorities. Instead of acting as a passive file repository, smart drive system 110 may organize information into secure, context-aware virtual folders. As described above, each folder may become a self-contained quantum-safe environment in which documents are not only stored, but also tokenized. For instance, the documents may be converted into cryptographically verifiable representations that may preserve their origin, structure, and history.

Smart drive system 110 may be founded on a quantum-safe architecture that anticipates the risks posed by future advances in computing. As discussed above, conventional encryption methods may become vulnerable in a post-quantum world that pushes traditional encryption measures to obsolescence. Each “virtual folder” and/or the project data structures contained therein may be protected using quantum-resistant cryptographic schemes as well as distributed or decentralized key management. These folders may function as secure containers, where access, edits, and sharing are governed by verifiable cryptographic controls rather than implicit trust in a central system. The result may be a storage model where data remains confidential and tamper-evident even against sophisticated or emerging threats, making it suitable for any organization handling sensitive or high-value information.

Distributed key management system(s) 1020 may work in conjunction with smart drive system 110 to provide enhanced security through distributed key components. The distributed key management system may store distributed key components from a plurality of key management components. Each distributed key component may be unable to individually decrypt document files. This distributed approach may ensure that no single point of failure can compromise the security of the stored documents, and access to files may require coordination between multiple key management components.

In some embodiments, distributed key management system(s) 1020 may comprise multiple distinct key management components, each configured to store and manage a portion of the cryptographic material required for document access. These key management components could include specialized hardware security modules, distributed computing nodes, or secure enclave systems that may each maintain separate cryptographic fragments. Each key management component may be geographically distributed and/or operate independently. Therefore, distributed key management system(s) 1020 may ensure that no single component can unilaterally grant access to encrypted document files. The coordination between these key management components may involve cryptographic protocols where multiple components must participate in a threshold-based scheme to reconstitute a complete decryption key. In some embodiments, smart drive system 110 may communicate with multiple distributed key management system(s) 1020 to form quantum-safe document management environment 1000.

Similar to the advantages discussed with reference to FIGS. 1-9, smart drive system 110 may also introduce a powerful operational advantage through its tokenization layer that generates quantum document tokens and quantum group document tokens. Documents may be tokenized through advanced quantum cryptographic protocols. For instance, smart drive system 110 may leverage quantum key distribution (QKD) techniques or post-quantum cryptographic algorithms to generate the quantum document tokens and quantum group document tokens. In some embodiments, the quantum document tokens may be created by applying quantum-resistant encryption schemes, such as lattice-based cryptography, hash-based signatures, or multivariate cryptographic systems, to the underlying document data. Smart drive system 110 may utilize quantum random number generators to produce cryptographically secure encryption for key generation. This enables each quantum document token to possess cryptographic properties that cannot be compromised even by quantum computing attacks.

Because documents may be stored as verifiable, distributed tokens rather than relying solely on a single system state, organizations can maintain uninterrupted access to critical information even during cyber incidents or infrastructure failures. This “always-available” design may eliminate the need for conventional restore processes and allow teams to continue working seamlessly, with confidence that the data they are accessing is authentic and unchanged.

As described above, blockchain 120 may provide an immutable ledger for recording document transactions, version histories, and access events within smart drive system 110. Blockchain 120 may maintain a sequence of document versions corresponding to document files, and for each document version in the sequence, blockchain 120 may log a version event record identifying at least a corresponding quantum file token, an event type corresponding to creation or modification, and the associated quantum cryptographic key. Blockchain 120 may assist in validating the integrity of version event records using quantum cryptographic keys and corresponding quantum document file tokens.

Artificial intelligence system(s) 1010 may be designed to support intelligent workflows without compromising trust within quantum-safe document management environment 1000. Each virtual folder may act as a controlled environment where artificial intelligence system(s) 1010 can analyze and interact with documents in a context-aware manner. Outputs generated within the workspace may be grounded in the verified document set, with clear traceability back to source material. Artificial intelligence system(s) 1010 may be subject to the same quantum-safe security measures. Access requests from AI agents may be validated using quantum cryptographic keys to ensure proper authorization before accessing project data structures.

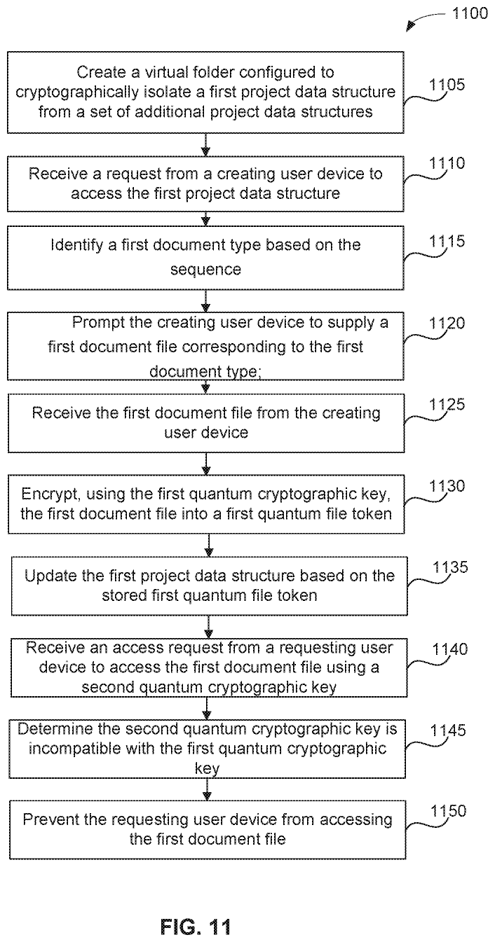

User devices 140 may, via user interfaces 130, communicate with smart drive system 110 in a similar manner discussed with reference to FIG. 1-10. The operations of smart drive system 110 in this context shall be discussed with regards to FIG. 11.

Smart drive system 110 may be designed with strict isolation between virtual folders to ensure that data remains compartmentalized across teams, projects, or clients. User device 140A with user interface 130A may access different project data structures than user device 140B with user interface 130B or user device 140C with user interface 130C, depending on the quantum cryptographic keys associated with each user device. This isolation may prevent unauthorized cross-contamination of data between different projects or organizational units.

In this way, the quantum-safe tokenized folder architecture in smart drive system 110 may transform the familiar concept of a shared drive into a secure, intelligent, and future-ready data environment applicable across industries, not tied to any single use case. The combination of smart drive system 110, blockchain 120, distributed key management system(s) 1020, artificial intelligence system(s) 1010, and user devices 140 with their respective user interfaces 130 may provide a comprehensive solution for organizations requiring the highest levels of data security and integrity in an evolving threat landscape.

FIG. 11 is a flowchart illustrating a method 1100 for configuring quantum-safe project data structures, according to some embodiments. Method 1100 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 11, as will be understood by a person of ordinary skill in the art.

Method 1100 shall be described with reference to FIGS. 1-9. However, method 1100 is not limited to those embodiments.

At step 1105, smart drive system 110 may create a virtual folder configured to cryptographically isolate a first project data structure from a set of additional project data structures. A virtual folder may refer to a logical construct that operates as a cryptographically-secured container within smart drive system 110. The virtual folder may define an isolated computational boundary that separates one set of project data structures from other project data structures via quantum-resistant encryption protocols. The virtual folder may implement a compartmentalized security model where access permissions, encryption keys, and data integrity controls can be managed independently from the physical file system structure. For example, the virtual folder may be associated with a first quantum cryptographic key.

In some embodiments, the quantum cryptographic key associated with a virtual folder may comprise a multi-layered cryptographic construct that can implement post-quantum encryption algorithms resistant to future computational threats. The quantum cryptographic key may be generated using lattice-based cryptographic methods, hash-based signature schemes, or other quantum-resistant algorithms that can maintain security even when subjected to quantum computational attacks. The quantum cryptographic key may be structured as a composite key containing multiple cryptographic components that can work together to provide enhanced security. The key may include a primary encryption component for data protection, a secondary authentication component for identity verification, and a tertiary integrity component for tamper detection. Each component may be independently rotatable and updatable, allowing smart drive system 110 to maintain continuous security without disrupting ongoing operations. The quantum cryptographic key may also incorporate time-based elements that can automatically expire or update according to predefined security policies, ensuring that even if a key component becomes compromised, the exposure window remains limited. To perform such operations, smart drive system 110 may use the quantum cryptographic key to further interface with distributed key management system 120 to enable secure key distribution processes. This enables smart drive system 110 to enforce access controls and data isolation at the folder level rather than requiring individual file-level security management.

At step 1110, smart drive system 110 may receive a request from a creating user device (e.g., user device 140A) to access the first project data structure. The first project data structure may identify a sequence of document types, similar to the sequence of document types described in FIGS. 1-9 above. For instance, the sequence of documents may refer to a flow of documents for completing a project, transaction, and/or process. The request may be transmitted through user interface 130A and processed by smart drive system 110.

In some embodiments, the request is authenticated using quantum-resistant cryptographic protocols maintained by smart drive system 110. The access request may be accompanied by a cryptographic key or a set of distributed key components configured to access the virtual folder. In some embodiments, the access request may include a folder access key derived from distributed key management system(s) 1020, where multiple key components may be combined to generate the necessary cryptographic credentials for folder access. The smart drive system 110 may verify that the accompanying key corresponds to the quantum cryptographic key originally associated with the virtual folder during its creation. The access request may be accompanied by a partial key component that is to be validated against additional key components stored across distributed key management system 120, thereby reconstructing the complete folder access credentials. Smart drive system 110 may also authenticate the provided key materials through blockchain 120 to ensure the requesting entity possesses sufficient cryptographic authority to access the folder contents. Smart drive system 110 may then use the accompanied key to decrypt the folder metadata and determine which documents or project data structures user device 140A can access within the virtual workspace.

At step 1115, smart drive system 110 may identify a first document type based on the sequence. Similar to the above embodiments, a user may upload a document file using user device 140. Upon receiving the document, smart drive system 110 may indicate that the document and/or step of the project, contractual flow, or other process has been completed. Smart drive system 110 may then identify a subsequent document for the user to provide to continue the project. In some embodiments, the identification process may be performed by artificial intelligence system(s) 1010, which may be configured to analyze the sequence parameters to determine the appropriate document classification. For example, as described above, the first document file may correspond to a contract or a document corresponding to a “thing” such as a person, property, animal, asset (e.g., boat, car, collectible artwork), and/or other objects. In this manner, the documents corresponding to the “thing” may be interconnected, which may provide a document of things or contract of things interconnectivity. The document may correspond to the project or “thing” and be interconnected with other documents in the first project structure, which may provide a document of things or contract of things interconnectivity.

At step 1120, smart drive system 110 may prompt the creating user device (e.g., user device 140A) to supply a first document file corresponding to the first document type. The prompt may be displayed through user interface 130A.

At step 1125, smart drive system 110 may receive the first document file from the creating user device (e.g., user device 140A). As described above, user device 140 may upload the first document file to smart drive system 110. In some embodiments, in a cloud system, user device 140 may designate the first document file over a network.

At step 1130, smart drive system 110 may encrypt, using the first quantum cryptographic key, the first document file into a first quantum file token. The first quantum file token may be stored to the first project data structure. The first quantum file token may indicate an access permission corresponding to the first document file. The encryption process leverages quantum-safe algorithms to generate the quantum file token. Additionally, the resulting token may be recorded on blockchain 120 for immutable provenance tracking. The tokenization process may involve smart drive system 110 applying the first quantum cryptographic key through a multi-layered encryption scheme that can transform the first document file and the content contained therein into a cryptographically secured token representation. The first quantum cryptographic key may be utilized to encrypt both the document content and its associated metadata through quantum-resistant algorithms, such as lattice-based cryptography or hash-based signatures, which could maintain security against quantum computing threats.

In some embodiments, smart drive system 110 may segment the document file into discrete data blocks, with each block being individually encrypted using portions of the first quantum cryptographic key, thereby creating a distributed token structure that can enhance both security and integrity verification. The resulting first quantum file token may encapsulate not only the encrypted document content but also embedded access control parameters that can define user permissions, modification rights, and sharing capabilities, all cryptographically bound to the first quantum cryptographic key. This tokenization approach may enable the document to exist as a self-contained cryptographic entity within the first project data structure. Here, the token itself can serve as both a secure storage mechanism and an access control gateway, with distributed key management system 120 potentially providing additional key derivation services to support fine-grained permission management across the tokenized document ecosystem.

At step 1135, smart drive system 110 may update the first project data structure based on the stored first quantum file token. Accordingly, the particular project data structure, reflects the current state of all tokenized documents and any changes and/or additions to the documents. The updates may also be propagated through blockchain 120 for distributed verification. In some embodiments, this update may occur in response to verifying that the first document file satisfies the first document type. In some embodiments, the validation may involve using the first quantum cryptographic key to verify cryptographic signatures or checksums associated with the first quantum file token, thereby confirming that the document content remains unchanged from its original state. The validation process may also compare hash values or other cryptographic identifiers stored within the first quantum file token against the current document state to detect any unauthorized modifications. Updating the project data structure may include marking the submission of the first document type. In this manner, when accessing a GUI to view the documents of the project data structure, a user may see an indication that the document has been submitted.

At step 1140, smart drive system 110 may receive an access request from a requesting user device (e.g., user device 140B) to access the first document file using a second quantum cryptographic key. In some embodiments, the second quantum cryptographic key may represent a distinct cryptographic identity associated with the requesting user device (e.g., user device 140B), which could be derived from a different key generation process, quantum entropy source, or cryptographic domain than the first quantum cryptographic key. The second quantum cryptographic key may be transmitted as part of the access request payload and could include quantum-resistant cryptographic signatures or other authentication mechanisms that enable smart drive system 110 to validate the requesting user's credentials. The access request may be processed through user interface 130B and evaluated by smart drive system 110.

In 1145, smart drive system 110 may determine the second quantum cryptographic key is incompatible with the first quantum cryptographic key. For example, this determination may involve a multi-layered cryptographic validation framework that can assess quantum key compatibility through several technical mechanisms. Smart drive system 110 may first extract cryptographic metadata from the second quantum cryptographic key received from requesting user device 140B, which could include quantum entropy parameters, algorithm identifiers, and key derivation histories that enable compatibility assessment. The system 110 may then compare these extracted parameters against corresponding metadata associated with the first quantum cryptographic key. Discrepancies in quantum-resistant algorithm families, key lengths, or cryptographic protocol versions may indicate fundamental incompatibility.

In some embodiments, smart drive system 110 may leverage distributed key management system(s) 1020 to perform cross-validation of the quantum cryptographic keys. The distributed architecture could enable parallel assessment of key compatibility across multiple cryptographic domains. This validation process may include executing quantum-safe verification protocols that can test whether the second quantum cryptographic key could successfully participate in the cryptographic operations required for document access, such as collaborative decryption or digital signature validation in the first project data structure. Smart drive system 110 may also assess temporal compatibility factors, where quantum cryptographic keys generated using different quantum-resistant standards or at different time periods may be deemed incompatible due to evolving cryptographic requirements or deprecated quantum-safe algorithms.

In some embodiments, upon determining incompatibility, smart drive system 110 could immediately terminate the access request session initiated through user interface 130B. Smart drive system 110 may also simultaneously log the attempted access event to blockchain 120 for immutable audit trail generation.

In 1150, smart drive system 110 may, based on the determining, prevent the requesting user device (e.g., user device 140B) from accessing the first document file. In some embodiments, smart drive system 110 may implement a multi-layered access prevention protocol that could include immediately terminating any active communication channels established with the requesting user device 140B. Smart drive system 110 may coordinate with distributed key management system(s) 1020 to revoke any temporary access tokens that could have been issued during the initial phases of the access request process. Smart drive system 110 may also trigger protective measures within the virtual folder infrastructure, such as temporarily isolating the requested document file from network-accessible storage locations and generating cryptographic proof of the access denial event. Smart drive system 110 may log the request and access denial through blockchain 120 audit trails.

In some embodiments, smart drive system 110 may identify a second document type based on the sequence and prompting the creating user device (e.g., user device 140A) through user interface 130A to supply a second document file corresponding to the second document type. Smart drive system 110 may receive the second document file from the creating user device 140A, and encrypt, using the first quantum cryptographic key, the second document file into a second quantum file token. The encryption process may be similar to the operations described above with respect to step 1130. The second quantum file token may be stored to the first project data structure and/or recorded on blockchain 120.

In some embodiments, smart drive system 110 may receive a subsequent access request to access the first document file from another user device 140, such as user device 140C. Based on the folder access request, smart drive system 110 may derive a folder access key for the first document file by obtaining distributed key components from a plurality of key management components in distributed key management system(s) 1020. Each distributed key component of the distributed key components may be unable to individually decrypt the first document file via the first quantum file token. For example, smart drive system 110 may retrieve distributed key components from separate key management nodes in distributed key management system(s) 1020 that must be combined to successfully decrypt the tokenized file. Smart drive system 110 may then decrypt the first document file by applying the distributed key components to the first quantum file token. Accordingly, smart drive system 110 may provide access to the first document file. These operations may be logged into blockchain 120.

In some embodiments, smart drive system 110 may receive a modification request from a modifying user device (e.g., user device 140C). The modification request may specify a request to modify the first document file. Smart drive system 110 may determine that the modifying user device 140C is enabled to modify the first document file by performing a series of authentication operations. For example, smart drive system 110 may detect that the modification request is accompanied by the distributed key components like those described above. Using the distributed key components, smart drive system 110 may decrypt the first document file. Smart drive system 110 may subsequently receive a modified first document file in place of the first document file. Smart drive system 110 may encrypt the modified first document file into a modified first quantum file token using the first quantum cryptographic key. Smart drive system 110 may generate the modified first quantum file token by applying the same first quantum cryptographic key to the modified document content, thereby creating a new encrypted representation that reflects the document changes while maintaining cryptographic continuity with the original token. The modified quantum file token may be created through a cryptographic transformation process that preserves the key-based access controls while updating the encrypted payload to correspond to the altered document data.

Smart drive system 110 may update the first project data structure based on the stored modified first quantum file token. The update may include mapping the modified first quantum file token to the original first quantum file token to maintain document versioning continuity within the first project data structure. Smart drive system 110 may further generate metadata associated with the modification event, which can include timestamp information, user identification data, and cryptographic verification signatures that correspond to the modified first quantum file token. All modification events may be recorded to blockchain 120.

In some embodiments, smart drive system 110 may record a sequence of document versions corresponding to the first document file in the first project data structure. For each document version in the sequence of document versions, smart drive system 110 may log a version event record on blockchain 120 identifying at least (i) a corresponding quantum file token (e.g., a first quantum file token, the modified quantum file token, etc.), (ii) an event type corresponding to creation or modification, or (iii) the first quantum cryptographic key. Smart drive system 110 may validate the integrity of the version event record of the first document file using the first quantum cryptographic key and the corresponding quantum document file token. For example, smart drive system 110 may validate the integrity of the version event record by cryptographically verifying that the version event record entry corresponds to the specific quantum file token through quantum-safe cryptographic operations. Smart drive system 110 may apply the first quantum cryptographic key to decrypt or authenticate the quantum document file token associated with the version event record, thereby confirming that the recorded version history has not been tampered with or corrupted.

In some embodiments, in instances by which the first document type corresponds to a group of documents, smart drive system 110 may encrypt, using the first quantum cryptographic key, the group of documents to generate a group quantum file token. The operations may be comparable with respect to those described in FIG. 8. Smart drive system 110 may deposit the first quantum file token and the group file quantum token in a digital wallet corresponding to the creating user device (e.g., user device 140A), with the wallet transactions being recorded on blockchain 120. Smart drive system 110 may generate the group quantum file token by applying a cryptographic hash function to the concatenated metadata and content signatures of each document within the group, thereby creating a composite token that cryptographically binds the individual documents while maintaining their separate encrypted states. The digital wallet transactions may be recorded on blockchain 120 using distributed consensus mechanisms that ensure immutable proof of the token creation and ownership transfer events.

In some embodiments, smart drive system 110 may receive a second request from the creating user device (e.g., user device 140A) to create a second project data structure within the virtual folder. The second project data structure may be associated with the first project data structure. Accordingly, smart drive system 110 may associate the second project data structure with the first quantum cryptographic key. For example, smart drive system 110 may ensure that any document stored within the second project data structure can be encrypted using the first quantum cryptographic key, thereby maintaining cryptographic consistency across related project structures within the same virtual folder. This configuration may enable seamless access control and security uniformity for documents that are logically grouped together under the same quantum-safe encryption scheme.

In some embodiments, smart drive system 110 may detect an access request originating from an AI agent to access the first project data structure, virtual folder, and/or a document contained therein. For example, an AI agent within artificial intelligence system(s) 1010 may attempt to access a component of smart drive system 110. The AI agent within artificial intelligence system(s) 1010 may attempt to access components of smart drive system 110 through various mechanisms and pathways. The AI agent may initiate direct API calls to smart drive system 110 and present quantum cryptographic credentials that could correspond to legitimate project access or unauthorized access attempts from different project data structures.

In some embodiments, the AI agent may present a quantum cryptographic key identical to the first quantum cryptographic key and be granted access to the smart drive system 110 component, as described above. Alternatively, the AI agent may also provide a quantum cryptographic key distinct from the first quantum cryptographic key. As such, smart drive system 110 may perform a cross-reference analysis against the set of additional project data structures to determine the AI agent's legitimate access permissions. The distributed key management system 120 may maintain a cryptographic mapping that associates each AI agent with its corresponding project data structure based on the quantum keys in its possession. If smart drive system 110 determines that the AI agent from artificial intelligence system(s) 1010 is associated with an additional project data structure from the set of additional project data structures rather than the first project data structure, the smart drive system 110 may implement access prevention protocols. This cryptographic isolation mechanism may ensure that the artificial intelligence system(s) 1010 cannot decrypt any content included in the first project data structure, even if it successfully authenticates against its own authorized project workspace. Accordingly, smart drive system 110 may maintain strict compartmentalization of sensitive information across different virtual folders within the quantum-safe document management environment 1000.

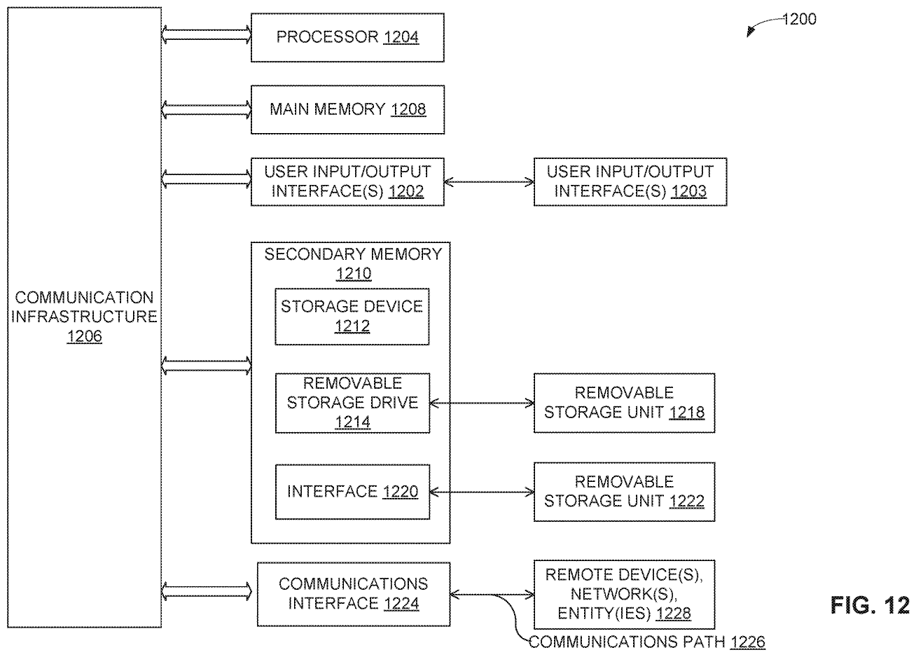

Various embodiments may be implemented, for example, using one or more well-known computer systems, such as computer system 1200 shown in FIG. 12. One or more computer systems 1200 may be used, for example, to implement any of the embodiments discussed herein, as well as combinations and sub-combinations thereof.

Computer system 1200 may include one or more processors (also called central processing units, or CPUs), such as a processor 1204. Processor 1204 may be connected to a communication infrastructure or bus 1206.

Computer system 1200 may also include user input/output device(s) 1203, such as monitors, keyboards, pointing devices, etc., which may communicate with communication infrastructure 1206 through user input/output interface(s) 1202.

One or more of processors 1204 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1200 may also include a main or primary memory 1208, such as random access memory (RAM). Main memory 1208 may include one or more levels of cache. Main memory 1208 may have stored therein control logic (i.e., computer software) and/or data.

Computer system 1200 may also include one or more secondary storage devices or memory 1210. Secondary memory 1210 may include, for example, a hard disk drive 1212 and/or a removable storage device or drive 1214. Removable storage drive 1214 may be a floppy disk drive, a magnetic tape drive, a compact disk drive, an optical storage device, tape backup device, and/or any other storage device/drive.

Removable storage drive 1214 may interact with a removable storage unit 1218. Removable storage unit 1218 may include a computer usable or readable storage device having stored thereon computer software (control logic) and/or data. Removable storage unit 1218 may be a floppy disk, magnetic tape, compact disk, DVD, optical storage disk, and/any other computer data storage device. Removable storage drive 1214 may read from and/or write to removable storage unit 1218.

Secondary memory 1210 may include other means, devices, components, instrumentalities or other approaches for allowing computer programs and/or other instructions and/or data to be accessed by computer system 1200. Such means, devices, components, instrumentalities or other approaches may include, for example, a removable storage unit 1222 and an interface 1220. Examples of the removable storage unit 1222 and the interface 1220 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1200 may further include a communication or network interface 1224. Communication interface 824 may enable computer system 1200 to communicate and interact with any combination of external devices, external networks, external entities, etc. (individually and collectively referenced by reference number 1228). For example, communication interface 1224 may allow computer system 1200 to communicate with external or remote devices 1228 over communications path 1226, which may be wired and/or wireless (or a combination thereof), and which may include any combination of LANs, WANs, the Internet, etc. Control logic and/or data may be transmitted to and from computer system 1200 via communication path 1226.

Computer system 1200 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1200 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1200 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1200, main memory 1208, secondary memory 1210, and removable storage units 1218 and 1222, as well as tangible articles of manufacture embodying any combination of the foregoing. Such control logic, when executed by one or more data processing devices (such as computer system 1200), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 12. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for configuring quantum-safe project data structures, the
computer-implemented method comprising:
creating a virtual folder configured to cryptographically isolate a first project data structure from a set of additional project data structures, wherein the virtual folder is associated with a first quantum cryptographic key;
receiving a request from a creating user device to access the first project data structure, wherein the first project data structure identifies a sequence of document types;
identifying a first document type based on the sequence of document types;
prompting the creating user device to supply a first document file corresponding to the first document type;
receiving the first document file from the creating user device;
encrypting, using the first quantum cryptographic key, the first document file into a first quantum file token, wherein the first quantum file token is stored to the first project data structure and wherein the first quantum file token indicates an access permission corresponding to the first document file;
updating the first project data structure based on the stored first quantum file token;
receiving an access request from a requesting user device to access the first document file using a second quantum cryptographic key;
determining the second quantum cryptographic key is incompatible with the first quantum cryptographic key; and
based on the determining, preventing the requesting user device from accessing the first document file.

2. The computer-implemented method of claim 1, further comprising:
identifying a second document type based on the sequence of document types;
prompting the creating user device to supply a second document file corresponding to the second document type;
receiving the second document file from the creating user device;
encrypting, using the first quantum cryptographic key, the second document file into a second quantum file token, wherein the second quantum file token is stored to the first project data structure and wherein the second quantum file token indicates an access permission corresponding to the second document file.

3. The computer-implemented method of claim 1, further comprising:
receiving a subsequent access request to access the first document file;
based on the subsequent access request, deriving a folder access key for the first document file by obtaining distributed key components from a plurality of key management components, wherein each distributed key component of the distributed key components is unable to individually decrypt the first document file; and
decrypting the first document file by applying the distributed key components to the first quantum file token, thereby providing access to the first document file.

4. The computer-implemented method of claim 3, further comprising:
receiving a modification request from a modifying user device, wherein the modification request specifies modifying the first document file;
determining the modifying user device is enabled to modify the first document file by detecting the modification request is accompanied by the distributed key components;
decrypting the first document file using the distributed key components, thereby enabling the modifying user device to modify the first document file;
receiving a modified first document file in place of the first document file;
encrypting, using the first quantum cryptographic key, the modified first document file into a modified first quantum file token, wherein the modified first quantum file token is stored to the first project data structure; and
updating the first project data structure based on the stored modified first quantum file token.

5. The computer-implemented method of claim 1, further comprising:
recording a sequence of document versions corresponding to the first document file in the first project data structure;
for each document version in the sequence of document versions, logging a version event record identifying at least (i) a corresponding quantum file token, (ii) an event type corresponding to creation or modification, or (iii) the first quantum cryptographic key; and
validating an integrity of the version event record of the first document file using the first quantum cryptographic key and the corresponding quantum document file token.

6. The computer-implemented method of claim 1, wherein the first document type corresponds to a group of documents, the computer-implemented method further comprising:
encrypting, using the first quantum cryptographic key, the group of documents to generate a group quantum file token; and
depositing the first quantum file token and the group file quantum token in a digital wallet corresponding to the creating user device.

7. The computer-implemented method of claim 1, further comprising:
receiving a second request from the creating user device to create a second project data structure within the virtual folder, wherein the second project data structure is associated with the first project data structure;
associating the second project data structure with the first quantum cryptographic key; and
configuring a document stored to the second project data structure to be encrypted using the first quantum cryptographic key.

8. The computer-implemented method of claim 1, further comprising:
detecting an access request originating from an artificial intelligence (AI) agent to access the first project data structure;
receiving a quantum cryptographic key distinct from the first quantum cryptographic key;
based on the receiving, determining the AI agent is associated with an additional project data structure from the set of additional project data structures; and
preventing the AI agent from decrypting content included in the first project data structure.

9. A system for configuring quantum-safe project data structures, the system comprising:
a memory; and
at least one processor coupled with the memory and configured to perform operations comprising:
creating a virtual folder configured to cryptographically isolate a first project data structure from a set of additional project data structures, wherein the virtual folder is associated with a first quantum cryptographic key;
receiving a request from a creating user device to access the first project data structure, wherein the first project data structure identifies a sequence of document types;
identifying a first document type based on the sequence of document types;
prompting the creating user device to supply a first document file corresponding to the first document type;
receiving the first document file from the creating user device;
encrypting, using the first quantum cryptographic key, the first document file into a first quantum file token, wherein the first quantum file token is stored to the first project data structure and wherein the first quantum file token indicates an access permission corresponding to the first document file;
updating the first project data structure based on the stored first quantum file token;
receiving an access request from a requesting user device to access the first document file using a second quantum cryptographic key;
determining the second quantum cryptographic key is incompatible with the first quantum cryptographic key; and
based on the determining, preventing the requesting user device from accessing the first document file.

10. The system of claim 9, wherein the operations further comprise:
identifying a second document type based on the sequence of document types;
prompting the creating user device to supply a second document file corresponding to the second document type;
receiving the second document file from the creating user device;
encrypting, using the first quantum cryptographic key, the second document file into a second quantum file token, wherein the second quantum file token is stored to the first project data structure and wherein the second quantum file token indicates an access permission corresponding to the second document file.

11. The system of claim 9, wherein the operations further comprise:
receiving a subsequent access request to access the first document file;
based on the subsequent access request, deriving a folder access key for the first document file by obtaining distributed key components from a plurality of key management components, wherein each distributed key component of the distributed key components is unable to individually decrypt the first document file; and
decrypting the first document file by applying the distributed key components to the first quantum file token, thereby providing access to the first document file.

12. The system of claim 11, wherein the operations further comprise:
receiving a modification request from a modifying user device, wherein the modification request specifies modifying the first document file;
determining the modifying user device is enabled to modify the first document file by detecting the modification request is accompanied by the distributed key components;
decrypting the first document file using the distributed key components, thereby enabling the modifying user device to modify the first document file;
receiving a modified first document file in place of the first document file;
encrypting, using the first quantum cryptographic key, the modified first document file into a modified first quantum file token, wherein the modified first quantum file token is stored to the first project data structure; and
updating the first project data structure based on the stored modified first quantum file token.

13. The system of claim 9, wherein the operations further comprise:
recording a sequence of document versions corresponding to the first document file in the first project data structure;
for each document version in the sequence of document versions, logging a version event record identifying at least (i) a corresponding quantum file token, (ii) an event type corresponding to creation or modification, or (iii) the first quantum cryptographic key; and
validating an integrity of the version event record of the first document file using the first quantum cryptographic key and the corresponding quantum document file token.

14. The system of claim 9, wherein the first document type corresponds to a group of documents, wherein the operations further comprise:
encrypting, using the first quantum cryptographic key, the group of documents to generate a group quantum file token; and
depositing the first quantum file token and the group file quantum token in a digital wallet corresponding to the creating user device.

15. The system of claim 9, wherein the operations further comprise:
receiving a second request from the creating user device to create a second project data structure within the virtual folder, wherein the second project data structure is associated with the first project data structure;
associating the second project data structure with the first quantum cryptographic key; and
configuring a document stored to the second project data structure to be encrypted using the first quantum cryptographic key.

16. The system of claim 9, wherein the operations further comprise:
detecting an access request originating from an artificial intelligence (AI) agent to access the first project data structure;
receiving a quantum cryptographic key distinct from the first quantum cryptographic key;
based on the receiving, determining the AI agent is associated with an additional project data structure from the set of additional project data structures; and
preventing the AI agent from decrypting content included in the first project data structure.

17. A non-transitory computer-readable device having instructions stored thereon that, when executed by at least one computing device, cause the at least one computing device to perform operations for configuring quantum-safe project data structures, the operations comprising:
creating a virtual folder configured to cryptographically isolate a first project data structure from a set of additional project data structures, wherein the virtual folder is associated with a first quantum cryptographic key;
receiving a request from a creating user device to access the first project data structure, wherein the first project data structure identifies a sequence of document types;
identifying a first document type based on the sequence of document types;
prompting the creating user device to supply a first document file corresponding to the first document type;
receiving the first document file from the creating user device;
encrypting, using the first quantum cryptographic key, the first document file into a first quantum file token, wherein the first quantum file token is stored to the first project data structure and wherein the first quantum file token indicates an access permission corresponding to the first document file;
updating the first project data structure based on the stored first quantum file token;
receiving an access request from a requesting user device to access the first document file using a second quantum cryptographic key;
determining the second quantum cryptographic key is incompatible with the first quantum cryptographic key; and
based on the determining, preventing the requesting user device from accessing the first document file.

18. The non-transitory computer-readable device of claim 17, wherein the operations further comprise:
identifying a second document type based on the sequence of document types;
prompting the creating user device to supply a second document file corresponding to the second document type;
receiving the second document file from the creating user device;
encrypting, using the first quantum cryptographic key, the second document file into a second quantum file token, wherein the second quantum file token is stored to the first project data structure and wherein the second quantum file token indicates an access permission corresponding to the second document file.

19. The non-transitory computer-readable device of claim 17, wherein the operations further comprise:
receiving a subsequent access request to access the first document file;
based on the subsequent access request, deriving a folder access key for the first document file by obtaining distributed key components from a plurality of key management components, wherein each distributed key component of the distributed key components is unable to individually decrypt the first document file; and
decrypting the first document file by applying the distributed key components to the first quantum file token, thereby providing access to the first document file.

20. The non-transitory computer-readable device of claim 19, wherein the operations further comprise:
receiving a modification request from a modifying user device, wherein the modification request specifies modifying the first document file;
determining the modifying user device is enabled to modify the first document file by detecting the modification request is accompanied by the distributed key components;
decrypting the first document file using the distributed key components, thereby enabling the modifying user device to modify the first document file;
receiving a modified first document file in place of the first document file;
encrypting, using the first quantum cryptographic key, the modified first document file into a modified first quantum file token, wherein the modified first quantum file token is stored to the first project data structure; and
updating the first project data structure based on the stored modified first quantum file token.
